(19) United States
(12) Patent Application Publication
(10) Pub. No.: US 2026/0058780 A1
(43) Pub. Date: Feb. 26, 2026

(54) DEVICE AND METHOD FOR PERFORMING SOUNDING SEQUENCE IN WIRELESS COMMUNICATION SYSTEM

(71) Applicant: Samsung Electronics Co., Ltd., Suwon-si (KR)

(72) Inventor: Eun Sung JEON, Suwon-si (KR)

(73) Assignee: Samsung Electronics Co., Ltd., Suwon-si (KR)

(21) Appl. No.: 19/251,286

(22) Filed: Jun. 26, 2025

(30) Foreign Application Priority Data
Aug. 26, 2024 (KR) 10-2024-0114212

(51) Int. Cl. H04L 5/00; H04B 17/309; H04W 84/12

(52) U.S. Cl. CPC H04L 5/0057; H04B 17/346; H04W 84/12

(57) ABSTRACT

Disclosed are a device and a method for performing a sounding sequence in a wireless communication system. A method of an access point communicating with a station in a wireless local area network (WLAN) system includes obtaining a null data packet announcement (NDPA) frame including one or more fields, the one or more fields being associated with an encoder for encoding channel information, and transmitting the NDPA frame to the station.

### CROSS-REFERENCE TO RELATED APPLICATIONS

This application claims priority under 35 U.S.C. § 119 to Korean Patent Application No. 10-2024-0114212 filed on Aug. 26, 2024, in the Korean Intellectual Property Office, the disclosures of which are incorporated by reference herein in their entireties.

### BACKGROUND

Embodiments of the present disclosure described herein relate to a device and a method for performing a sounding sequence in a wireless communication system.

As an example of wireless communication, a wireless local area network (WLAN) is a technology that connects two or more devices by using a wireless signal transmission scheme, and WLAN technology may be based on the Institute of Electrical and Electronics Engineers (IEEE) 802.11 standard. Since 802.11ac, data may be transmitted to multiple users simultaneously (or contemporaneously) through multi-user multi-input multi-output (MU-MIMO) technology.

In a MU-MIMO communication environment, a beamforming process may be used to improve communication performance. The beamforming process includes a sounding sequence. Through the sounding sequence, a beamformee may feedback channel information to a beamformer. As the size of the channel information being fed back increases, the overhead for the feedback increases, limiting the size of the channel information that may be fed back.

### SUMMARY

Embodiments of the present disclosure provide a device and a method for performing a sounding sequence in a wireless communication system.

According to embodiments, a method of an access point communicating with a station in a wireless local area network (WLAN) system includes obtaining a null data packet announcement (NDPA) frame including one or more fields, the one or more fields being associated with an encoder for encoding channel information, and transmitting the NDPA frame to the station.

According to embodiments, an access point communicating with a station in a wireless local area network (WLAN) system includes one or more transceivers, one or more processors electrically connected to the one or more transceivers, and one or more memories electrically connected to the one or more processors to store one or more instructions wherein the one or more processors are configured to execute the one or more instructions to obtain a null data packet announcement (NDPA) frame including one or more fields, the one or more fields being associated with an encoder for encoding channel information, and transmit the NDPA frame to the station through the one or more transceivers.

According to embodiments, a method of a station communicating with an access point in a wireless local area network (WLAN) system includes receiving a null data packet announcement (NDPA) frame including one or more fields, the one or more fields being associated with an encoder, receiving a null data packet (NDP) from the access point, the NDP corresponding to the NDPA frame, estimating channel information based on the NDP, encoding the channel information based on the encoder to obtain encoded channel information, and transmitting a compressed beamforming report (CBR) frame to the access point, the CBR frame including the encoded channel information.

### BRIEF DESCRIPTION OF THE FIGURES

The above and other objects and features of the present disclosure will become apparent by describing in detail embodiments thereof with reference to the accompanying drawings.

FIG. 1 illustrates a wireless communication system according to embodiments.

FIG. 2 illustrates the structure of an extremely high throughput (EHT) trigger based (TB) physical protocol data unit (PPDU).

FIG. 3 illustrates the structure of an EHT MU PPDU.

FIG. 4 illustrates single-user based channel sounding according to embodiments.

FIG. 5 illustrates multi-user based channel sounding according to embodiments.

FIG. 6 illustrates the frame structure of an NDPA frame.

FIG. 7 illustrates an STA Info field included in an EHT NDPA frame.

FIG. 8 illustrates a frame structure of an EHT sounding NDP frame.

FIG. 9 illustrates the structure of an EHT CBR frame.

FIG. 10 illustrates the EHT MIMO control field in FIG. 9.

FIG. 11 illustrates a WLAN beamforming system.

FIG. 12 illustrates subcarrier grouping.

FIG. 13 illustrates an STA according to embodiments.

FIG. 14 illustrates the encoder of FIG. 13 according to embodiments.

FIG. 15 illustrates an STA according to embodiments.

FIG. 16 illustrates an STA according to embodiments

FIG. 17 illustrates an encoder according to embodiments.

FIG. 18 illustrates a perceptron included in a neural network.

FIG. 19 illustrates the frame structure of an NDPA frame according to embodiments.

FIG. 20 illustrates the frame structure of an NDPA frame according to embodiments.

FIG. 21 illustrates subfields of a first field according to embodiments.

FIG. 22 illustrates a (1-2)-th subfield according to embodiments.

FIG. 23 illustrates the frame structure of an NDPA frame according to embodiments.

FIG. 24 illustrates an example of the NDPA frame of FIG. 23.

FIG. 25 illustrates subfields of a second field according to embodiments.

FIG. 26 illustrates an example of the subfield in FIG. 25.

FIG. 27 illustrates some subfields included in the second field of FIG. 25 according to embodiments.

FIG. 28 illustrates examples of scenarios related to encoder settings.

FIG. 29 illustrates a structure of a CBR frame according to embodiments.

FIG. 30 illustrates some fields of the CBR frame of FIG. 29.

FIG. 31 illustrates an AP according to embodiments.

FIG. 32 illustrates a decoder of FIG. 31 according to embodiments.

FIG. 33 is a flowchart illustrating an operation method of an AP according to embodiments.

FIG. 34 is a flowchart illustrating an operation method of an AP according to embodiments.

FIG. 35 is a flowchart illustrating an operation method of an STA according to embodiments.

FIG. 36 is a block diagram illustrating a wireless communication device according to embodiments.

### DETAILED DESCRIPTION

Hereinafter, embodiments of the present disclosure will be described clearly and in detail so that those skilled in the art may easily carry out embodiments of the present disclosure.

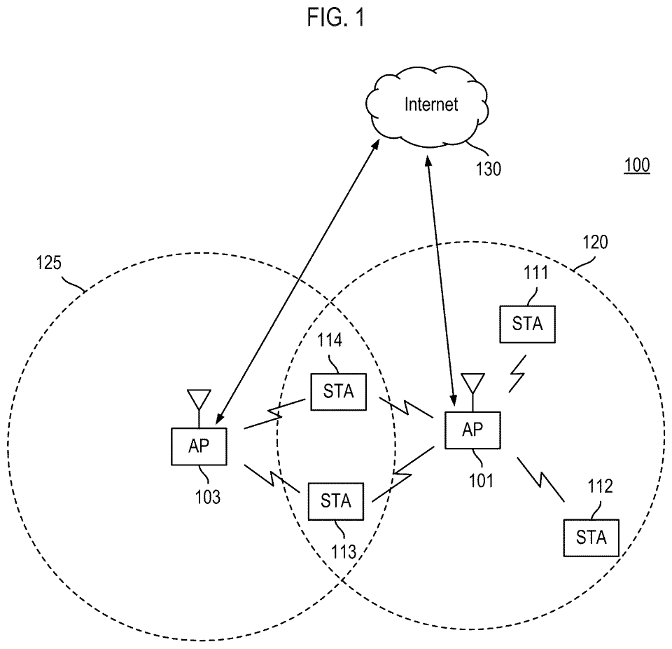

FIG. 1 illustrates a wireless communication system according to embodiments.

Referring to FIG. 1, a wireless communication system 100 may include a plurality of access points (APs) 101 and 103 and/or a plurality of stations (STAs) 111 to 114. In detail, the APs 101 and 103 may communicate with at least one network 130, such as the Internet, an Internet protocol (IP) network, and the like.

The APs 101 and 103 may provide wireless access to the network 130 such that the STAs 111 to 114 within each of coverage areas 120 and 125 use communication services. For example, the APs 101 and 103 may communicate with each other by using wireless fidelity (Wi-Fi) or other WLAN communication technologies. In addition, the APs 101 and 103 may communicate with the plurality of STAs 111 to 114 by using Wi-Fi or other WLAN communication technologies.

For reference, depending on the network type, other well-known terms such as “router” and “gateway” may be used instead of “AP” or “access point”. In addition, in a WLAN, an AP may be provided for a wireless channel. An AP may be identified as an STA to other APs depending on its operation. The AP of the present application may also be referred to as a device, a wireless device, a communication device, or the like.

In addition, depending on the network type, the STA may be used instead of other well-known terms such as a mobile station, a subscriber station, a remote terminal, user equipment, a wireless terminal, a user device, or a user. For convenience, the term STA is used in this application to refer to a remote wireless device that wirelessly connects to an AP or accesses a wireless channel within a WLAN. An STA may be identified as an AP by other STAs depending on its operation. The STA of the present application may also be referred to as a device, a wireless device, a communication device, or the like.

In embodiments, the APs 101 and 103 may be included in different devices, or may be included in one device (AP multiple link device (MLD)). In addition, the STAs 111 to 114 may be included in different devices or in one device (non-AP MLD).

The dotted lines illustrate the approximate extents of the coverage areas 120 and 125. In this case, the coverage areas 120 and 125 are illustrated as being approximate circles for illustration and description. However, the coverage areas 120 and 125 associated with the APs 101 and 103 may have different shapes reflecting various changes in wireless environments related to natural or artificial obstructions, or may have different shapes including irregular shapes depending on the settings of the APs 101 and 103.

The APs 101 and 103 may include circuitry and/or programs for managing uplink multi-user (UL MU) or downlink MU (DL MU) transmission in a WLAN system.

In addition, FIG. 1 only illustrates an example of the wireless communication system 100, but embodiments of the present application are not limited thereto.

For example, the wireless communication system 100 may include an arbitrary number of APs and an arbitrary number of STAs arbitrarily arranged. In addition, the AP 101 may communicate directly with an arbitrary number of STAs. In detail, the AP 101 may provide wireless broadband access to the network 130 to the STAs 111 to 114.

Similarly, each of the APs 101 and 103 may communicate directly with the network 130 and provide wireless broadband access to the STAs 111 to 114 in the network 130. In addition, the APs 101 and 103 may implement connections with various external networks, such as external telephone networks or data networks. Hereinafter, in order to explain embodiments of the present application, the configuration and operation of the AP 101 and the STA 111 will be mainly described, and the described examples may also be applied to the remaining AP 103 and STAs 112 to 114.

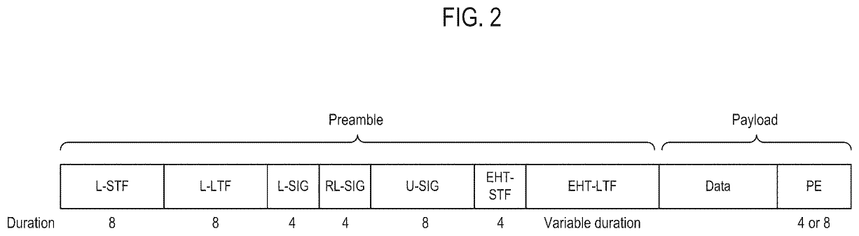

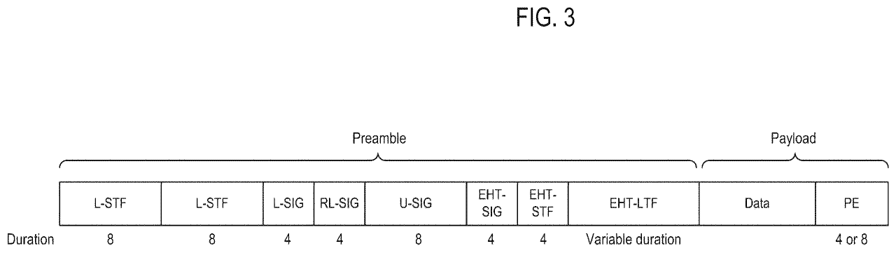

FIG. 2 illustrates the structure of an extremely high throughput (EHT) trigger based (TB) physical protocol data unit (PPDU). FIG. 3 illustrates the structure of an EHT MU PPDU.

Referring to FIGS. 2 and 3, each EHT PPDU may include a preamble including a plurality of training fields and a plurality of signaling fields, and/or a payload including a data field and a packet extension (PE).

In detail, each EHT PPDU may include a legacy-short training field (L-STF), a legacy-long training field (L-LTF), a legacy-signal (L-SIG) field, a repeated legacy-signal (RL-SIG) field, a universal signal (U-SIG) field, an extremely high throughput-short training field (EHT-STF), an extremely high throughput-long training field (EHT-LTF), a data field, and/or a PE field for packet extension.

The EHT TB PPDU of FIG. 2 does not include an extremely high throughput-signal (EHT-SIG) field, but the symbol of EHT-STF may be repeated. The EHT MU PPDU of FIG. 3 may include a plurality of orthogonal frequency division multiplexing (OFDM) symbols and may further include an EHT-SIG.

In addition, in the case of EHT TB PPDU of FIG. 2, a trigger frame may be required to (or otherwise, may) indicate a frequency resource before uplink transmission.

The L-STF may include a short training OFDM symbol and may be used for frame detection, automatic gain control (AGC), diversity detection, and coarse frequency/time synchronization.

The L-LTF may include a long training OFDM symbol and may be used for fine frequency/time synchronization and channel prediction.

The L-SIG may be used for control information transmission and may include information about a data rate and a data length. For reference, the L-SIG may be transmitted repeatedly, and the format in which the L-SIG is repeated is called RL-SIG.

The U-SIG is placed immediately following (or next to) the RL-SIG field and may include two OFDM symbols commonly encoded. In detail, the U-SIG may include ‘version-independent fields’ and ‘version-dependent fields’, and the ‘version-dependent fields’ may be placed after the ‘version-independent fields’. In this case, the ‘version-independent fields’ may have static location and bit definition across different generations/physical versions.

In addition, for example, the ‘version-independent fields’ may include the following control information:
1) PHY version identifier (e.g., physical version identifier; consisting of (or including) 3 bits)
2) UL/DL flag (consisting of (or including) 1 bit)
3) BSS color (e.g., BSS color field, which is the identifier of a basic service set (BSS))
4) TXOP duration (e.g., a field indicating the remaining time of a current transmission opportunity (TXOP) section)
5) Bandwidth (e.g., a bandwidth field; note that the bandwidth field may also carry some puncturing information)

The ‘version-dependent fields’ may have variable bit definitions for each physical version.

In addition, for example, the ‘version-dependent fields’ may include the following control information:
1) PPDY type (field indicating PPDU type)
2) EHT-SIG MCS (a field that indicates a modulation and coding scheme (MCS) applied to EHT-SIG, and exists in the U-SIG of the EHT PPDU transmitted to a MU)
3) Number of EHT-SIG Symbols (a field that indicates the number of symbols used for EHT-SIG, and exists in the U-SIG of the EHT PPDU transmitted to an MU)

The U-SIG may further include various information as well as the control information described above, or may not include some of the control information described above. In addition, in environments other than MU environments, some information may be added to the U-SIG or some information may be omitted from the U-SIG.

The EHT-SIG may be arranged immediately following (or next to) the U-SIG field in the EHT PPDU transmitted to the MU and may have a variable MCS scheme and length.

In addition, the EHT-SIG may include a common field including common control information and a user-specific field including user-specific control information.

In this case, the common field may be encoded separately from the user-specific field. In addition, the common field may include information (e.g., a RU allocation subfield) related to resource unit (RU) allocation, and the user-specific field may include information similar to the information (e.g., user information allocated to each RU) included in the user-specific field of a high efficiency (HE)-SIG-B.

For reference, the common field of the EHT-SIG field of the EHT PPDU transmitted to an MU may have at least one compression mode in which the RU Allocation subfield does not exist. In addition, the EHT-SIG may be used basically in the PPDU for an MU, but when the overhead of U-SIG increases, it may also be used in the PPDU for single-user (SU) transmission, unlike the HE PPDU.

As described above, the EHT-SIG field may be configured, and a more detailed description of the EHT-SIG will be omitted.

The EHT-STF field is used to improve automatic gain control (AGC) estimation in multiple-input multiple-output (MIMO) transmissions.

The EHT-LTF field is used for MIMO channel estimation between the output set of the constellation mapper and the receive chain.

As described above, various EHT PPDUs may be used in standards of the Institute of Electrical and Electronics Engineers (IEEE), and each field of the preamble and payload of the EHT PPDU may be configured as described above.

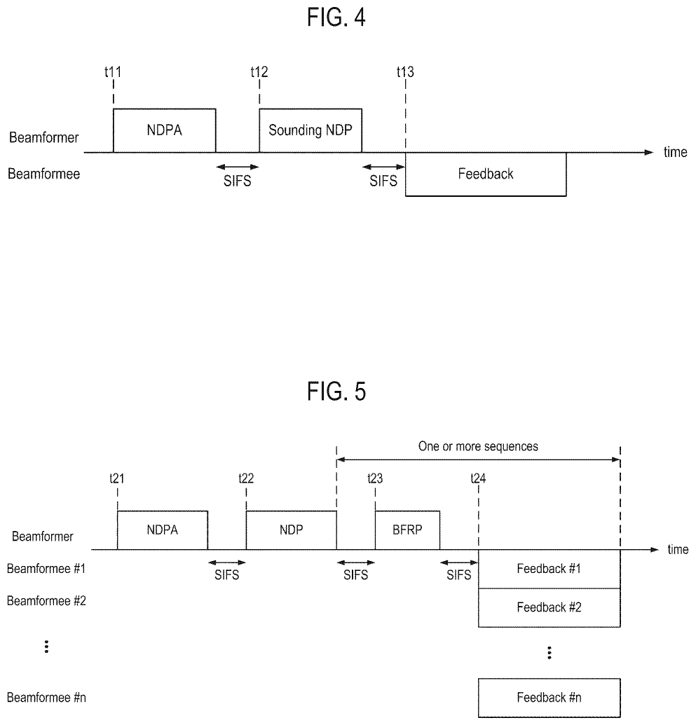

FIG. 4 illustrates single-user based channel sounding according to embodiments.

Referring to FIG. 4, channel sounding may be performed through a beamformer and a beamformee. In embodiments, the beamformer may be an AP and the beamformee may be an STA. In addition, in the present application below, the beamformer and the AP may be used interchangeably, and the beamformee and the STA may be used interchangeably.

In a WLAN system, beamforming may be performed to improve reception performance for a single user or multiple users. SU-MIMO and DL MU-MIMO beamforming are techniques used by STAs having multiple antennas to steer signals using known channels to improve throughput. Through SU-MIMO, all spatial streams of a transmitted signal may be designed to be received by one STA in an RU or multi RU (MRU). Through DL MU-MIMO, disjoint subsets of spatial streams may be designed to be received by different STAs in an RU or MRU of size 242 tones or larger.

The beamformer receives channel information from the beamformee. To receive channel information, the beamformer may transmit a sounding signal for channel estimation and channel information feedback of the beamformee. The procedure by which a beamformer transmits or receives a series of signals including sounding signals to receive the feedback of the channel state information from the beamformee may be defined as a sounding sequence (or sounding protocol). For example, FIG. 4 illustrates a sounding sequence for a single user.

Through the sounding sequence, the AP may perform beamforming for optimal (or improved) signal transmission and reception.

Sounding sequences, which are explicit feedback mechanisms, may be classified into non-trigger-based sounding sequences and trigger-based sounding sequences. In all sequences, the beamformee may estimate a channel by using a training signal (e.g., sounding NDP) and may feedback the estimated channel state (or channel information) to the beamformer. The beamformer may derive a steering matrix by using the feedback information. The sounding sequence in FIG. 4 is ‘non-trigger based’ for a single user.

First, at time point t11, before transmitting a null data packet (NDP) which is a sounding signal, the beamformer may transmit an NDP announcement (NDPA) frame to the beamformee to notify the NDP transmission. The NDPA frame is a control frame used to indicate that an NDP will be transmitted in the sounding sequence. In addition, the NDP, which is a sounding signal for a sounding sequence, may also be referred to as a ‘sounding NDP’, a ‘sounding signal’, or the like. When the beamformee receives an NDPA frame from the beamformer, the beamformee may prepare for channel information estimation and feedback before receiving the NDP.

After transmitting the NDPA frame, the beamformer may transmit the NDP to the beamformee after a short inter-frame space (SIFS) interval (e.g., at time point t12). For example, the SIFS may be 16 us.

The beamformee may receive the NDP and perform channel estimation based on the received NDP. In a non-trigger based sounding sequence, the beamformee may load the channel information estimated from the NDP into a compressed beamforming report (CBR) frame and feedback it to the beamformer within the SIFS (e.g., at time point t13) after transmitting the NDP.

FIG. 5 illustrates multi-user based channel sounding according to embodiments. It is assumed in FIG. 5 that trigger based channel sounding is for multiple users.

Referring to FIG. 5, a sounding sequence according to embodiments may be performed by a beamformer and a plurality of beamformees (wherein ‘n’ is a natural number greater than or equal to 2). For the plurality of beamformees, the same (or similar) or different protocol standards may be supported.

At time point t21, the beamformer may transmit an NDPA frame to the plurality of beamformees before transmitting an NDP.

At time point t22 within the SIFS after the NDPA frame transmission is completed, the beamformer may transmit the NDP to the plurality of beamformees. In addition, in a trigger-based sounding sequence, the beamformer may transmit a beamforming report poll (BFRP) frame of requesting feedback of channel information to each beamformee after transmitting the NDPA frame and NDP. The operation of transmitting a BFRP frame may be determined as triggering a feedback request. The difference between non-trigger-based and trigger-based sounding sequences is the transmission of the BFRP frame. The beamformer may transmit the BFRP frame at time point t23 within the SIFS after transmitting the NDP.

Each beamformee may perform channel estimation based on the received NDP. After transmitting the BFRP frame, at time point t24 within the SIFS, each beamformee may load the estimated channel information into a CBR frame and transmit it to the beamformer.

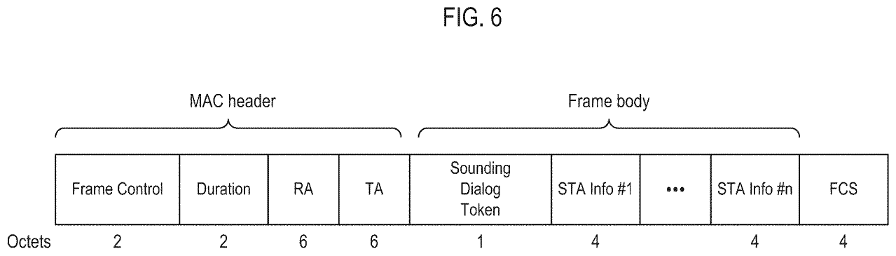

FIG. 6 illustrates the frame structure of an NDPA frame.

Referring to FIG. 6, the NDPA frame may include a multiple access channel (MAC) header, a frame body, and a frame check sequence (FCS) field for error detection. The MAC header may include a frame control field, a duration field, a RA field, and/or a TA field. The frame body may include a sounding dialogue token number field and n STA Info fields.

First, the frame control field may include information about the version of the MAC protocol and other additional control information. The duration field may contain time information for setting up a network allocation vector (NAV) or information about a user's identifier (e.g., association identifier (AID)). The RA field may include address information of a beamformee receiving an NDPA frame. The TA field may include address information of a beamformer transmitting an NDPA frame.

The sounding dialogue token number field may be referred to as a sounding sequence field and may include identification information of the NDPA frame.

The STA Info field may be referred to as a user information field. The STA Info field may correspond to each STA, and one or more may be included in the NDPA frame. When there are multiple STA Info fields, the number of STA Info fields may correspond to the number of multiple beamformees receiving the NDPA frame. That is, the beamformer transmitting the NDPA frame may insert n STA Info fields into the NDPA frame when it is desired to perform beamforming for n users. For example, each STA Info field may have a size of 4 bytes.

The structure of the NDPA frame of FIG. 6 described above may be commonly applied to a very high throughput (VHT)/high efficiency (HE) NDPA frame, a ranging NDPA frame, an EHT NDPA frame, and the like.

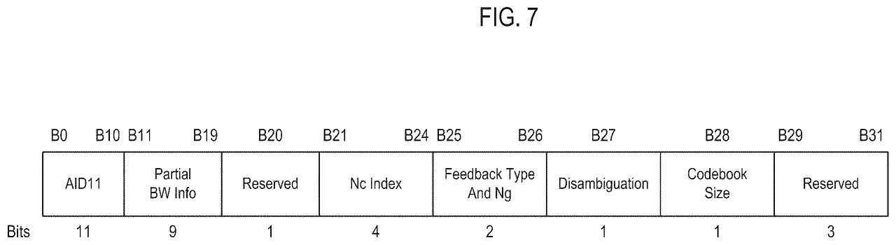

FIG. 7 illustrates an STA Info field included in an EHT NDPA frame.

Referring to FIG. 7, each STA information field included in the EHT NDPA frame may include an AID subfield, a partial BW Info subfield, an Nc index subfield, a feedback type and Ng subfield, a disambiguation subfield, a codebook size subfield, and/or a reserved subfield. As illustrated, the reserved subfield may be inserted between the partial BW Info subfield and the Nc index subfield, or after the codebook size subfield.

The AID subfield may include ID information of the STA. The ID information may be information that the beamformer assigns to each STA that is a beamforming target. For an EHT NDPA frame, the AID subfield may be an AID11 subfield defined in the IEEE standard. The AID11 subfield may include an identifier of an STA that is expected to process a subsequent EHT sounding NDP and prepare sounding feedback.

The partial BW Info subfield may include a resolution subfield and a feedback bitmap subfield. The resolution subfield indicates the resolution bandwidth of each bit within the feedback bitmap subfield. The feedback bitmap subfield indicates whether feedback is requested for each resolution bandwidth, ordered from lowest to highest frequency. For example, the feedback bitmap subfield may include bits of B1 through B8, with the B1 bit set to ‘1’ indicating a feedback request for the lowest frequency in the indicated resolution bandwidth.

The Nc index subfield indicates (the number of columns−1) in the compressed beamforming feedback matrix when the feedback type and Ng subfield and the codebook size subfield indicate an SU or MU. Alternatively, the Nc index subfield indicates (the number of spatial streams−1) in the CQI report when the feedback type and Ng subfield and the codebook size subfield indicate a channel quality indicator (CQI).

Each of the feedback type and Ng subfield and the codebook size subfield may have 1 bit. The bit combinations of the feedback type and Ng subfield and the codebook size subfield may indicate an SU or MU, the subcarrier grouping value Ng, and the quantization resolution.

The disambiguation subfield may prevent other STAs (e.g., non-EHT STAs) from misidentifying the AID in an EHT NDPA frame (or reduce the likelihood thereof).

Each STA may identify a STA information field with a matching AID value in an NDPA frame, and may refer to parameters (resolution bandwidth, frequency for which feedback is requested, Nc, feedback type, Ng, and/or quantization resolution, and the like) for feedbacking channel information from the identified STA information field.

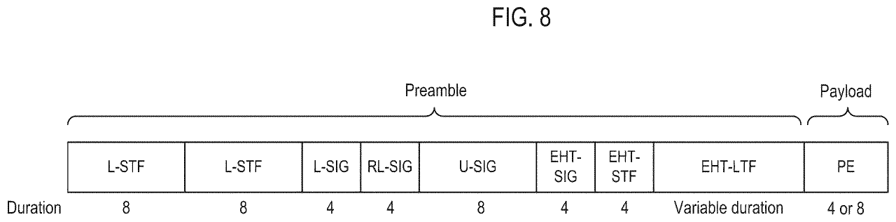

FIG. 8 illustrates a frame structure of an EHT sounding NDP frame.

Referring to FIG. 8, the EHT sounding NDP frame may include L-STF, L-LTF, L-SIG, RL-SIG, U-SIG, EHT-SIG, EHT-STF, EHT-LTF, and/or PE. Unless otherwise stated, the functions of the above-described fields may be identical (or similar) to the fields included in the EHT TB PPDU and EHT MU PPDU.

In an EHT sounding NDP frame, a single EHT-SIG symbol is encoded into EHT-MCS 0. The EHT sounding NDP frame may be determined as an EHT MU PPDU without a data field. The EHT-SIG field does not include any user-specific field. When the beamforming subfield in the EHT-SIG is ‘1’, the receiver (e.g., STA) of the EHT sounding NDP frame does not perform channel smoothing when reporting compressed beamforming feedback.

An STA, which is a receiver of an EHT sounding NDP frame, may estimate a channel through the EHT-LTF included in the corresponding frame and report the estimated channel information to the AP through a CBR frame.

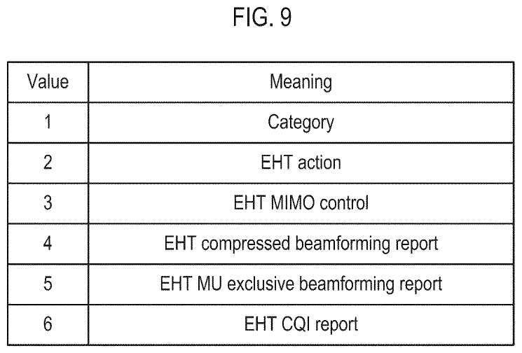

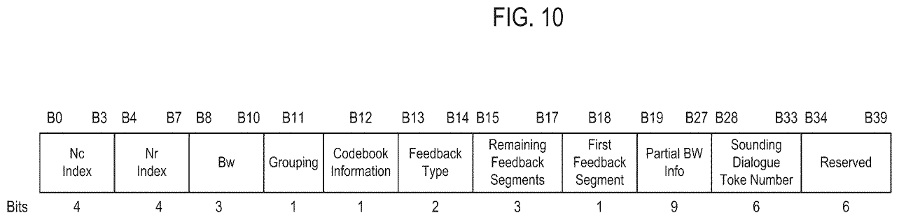

FIG. 9 illustrates the structure of an EHT CBR frame, and FIG. 10 illustrates the EHT MIMO control field in FIG. 9.

Referring to FIG. 9, an EHT CBR frame, which is a frame generated from an STA (e.g., a beamformee), may include, in order, a category field, an EHT action field, an EHT MIMO control field, an EHT compressed beamforming report field, an EHT MU exclusive beamforming report field, and/or an EHT CQI report field.

The category field is set to a value indicating an EHT category (e.g., an EHT action field), and the EHT action field is set to a value indicating an EHT compressed beamforming report field.

The EHT MIMO control field includes information about the EHT CBR frame. Referring to FIG. 10, the EHT MIMO control field may include an Nc index subfield, an Nr index subfield, a BW subfield, a grouping subfield, a codebook information subfield, a feedback type subfield, a remaining feedback segment subfield, a first feedback segment subfield, a partial BW Info subfield, a sounding dialogue token number subfield, and/or a reserved subfield.

The Nc index subfield indicates (the number of columns of the compressed beamforming feedback matrix−1) when the feedback type subfield indicates an SU or MU, and (the number of spatial streams−1) when the feedback type subfield indicates a CQI.

The Nr index subfield indicates (the number of rows of the compressed beamforming feedback matrix−1) when the feedback type subfield indicates an SU or MU, and is reserved when the feedback type subfield indicates a CQI.

The BW subfield corresponds to the BW of the EHT sounding NDP.

The grouping subfield indicates the grouping value Ng when the feedback type subfield indicates an SU or MU, and is reserved when the feedback type subfield indicates a CQI.

The codebook information subfield indicates the size of codebook entries, which are quantization-related information.

The feedback type subfield indicates the feedback type (e.g., SU, MU or CQI).

The remaining feedback segment subfield indicates the number of remaining feedback segments for the associated EHT compressed beamforming/CQI frame.

The first feedback segment subfield is set to ‘0’ or ‘1’. The first feedback segment subfield is set to ‘1’ for the first feedback segment of a segmented report or the only feedback segment of a non-segmented report. Alternatively, the first feedback segment subfield is set to ‘0’ when it is not the first feedback segment or when the EHT compressed beamforming report field and the EHT MU exclusive beamforming report field are not present in the frame.

The partial BW Info subfield and the sounding dialogue token number subfield are identical (or similar) to the subfields included in the EHT NDPA frame described above.

Returning to FIG. 9, the EHT compressed beamforming report field may transmit the average signal-to-noise ratio (SNR) of each space-time stream used to transmit data and the compressed beamforming feedback matrix. For example, the EHT compressed beamforming report field may be structured as shown in following Table 1.

TABLE 1

| Field | Size (bits) | Meaning |
|---|---|---|
| Average SNR of | 8 | SNR at the beamforme [symbol] for |
| Space-Time Stream 1 | | spacetime stream 1 averaged |
| | | over all data subcarriers |
| ≡ | ≡ | ≡ |
| Average SNR of | 8 | SNR at the beamforme [symbol] for |
| Space-Time StreamNc | | spacetime stream Nc averaged |
| | | over all data subcarriers |
| Compressed beamforming | Na × (b [symbol] + | Compressed beamforming |
| feedback matrix V for | b [symbol] )/2 | feedback matrix in Table 2 |
| subcarrier [symbol] | | |
| ≡ | ≡ | ≡ |
| Compressed beamforming | Na × (b [symbol] + | Compressed beamforming |
| feedback matrix V for | b [symbol] )/2 | feedback matrix in Table 2 |
| subcarrier [symbol] | | |

[symbol]

indicates data missing or illegible when filed

Referring to Table 1, the EHT compressed beamforming report field includes fields indicating the SNR measured at the beamformee. In this case, the SNR may be the average of each space-time stream for all data subcarriers. The number of space-time streams may be defined as Nc.

In addition, the EHT compressed beamforming report field includes fields indicating a compressed beamforming feedback matrix for each subcarrier k (where k is a subcarrier index from ‘0 (zero)’ to Ns (where Ns is the number of subcarriers over which the compressed beamforming feedback matrix is transmitted to the beamformer)). The scidx( ) represents the subcarrier on which the compressed beamforming feedback matrix is transmitted. In this case, the size of each field is defined as Na×(b++b)/2, where Na is the number of angles, b_{ϕ} is the bit size of angle Φ, and b_{ψ} is the bit size of angle Ψ.

Hereinafter, Φ is defined as a first angle and Ψ is defined as a second angle. In addition, the bit size may also be referred to as the codebook size. The angle may be compressed information of the beamforming feedback matrix measured for each subcarrier. The angles calculated through compression are transmitted through the EHT compressed beamforming report field.

For example, angles may be included in the EHT compressed beamforming report field in a form similar to in Table 2.

TABLE 2

| Size of V | Number of angles | The order of angles in the Compressed |
|---|---|---|
| (Nr × Nc) | (Na) | Beamforming Feedback Matrix subfield |
| 2 × 1 | 2 | Φ11, Ψ21, |
| 2 × 2 | 2 | Φ11, Ψ21, |
| 3 × 1 | 4 | Φ11, Φ21, Ψ21, Ψ31, |
| 3 × 2 | 6 | Φ11, Φ21, Ψ21, Ψ31, Φ22, Ψ32 |
| 3 × 3 | 6 | Φ11, Φ21, Ψ21, Ψ31, Φ22, Ψ32 |
| 4 × 1 | 6 | Φ11, Φ21, Φ31, Ψ21, Ψ31, Ψ41 |
| 4 × 2 | 10 | Φ11, Φ21, Φ31, Ψ21, Ψ31, Ψ41, |
| | | Φ22, Φ32, Ψ32, Ψ42 |
| ≡ | ≡ | ≡ |

Where ‘V’ is a beamforming feedback matrix. In Table 2, the number of angles (Na) and the order of the angles may be defined for each size of the beamforming feedback matrix. For example, the number of angles included in the beamforming feedback matrix having a size of 2×1 is 2, and the first angle Φ11 and the second angle Ψ21 are included in the beamforming feedback matrix.

The EHT MU exclusive beamforming report field may only be included in the case of MU beamforming. The EHT MU exclusive beamforming report field transmits explicit feedback in the form of delta SNR. The delta SNR may be defined as the difference between the SNR of each subcarrier and the average SNR. According to embodiments, a different delta SNR may be provided with respect to each of several subcarriers.

The beamformee may calculate the delta SNR based on following Equation 1.

$$\begin{matrix}Δ {SNR}_{k , i} = min {( max ( round ( 10 {log}_{10} ( \frac{{‖ {H}_{k} {V}_{k , i} ‖}^{2}}{{P}_{N , i}} ) - {\overline{SNR}}_{i} ) , - 8 ) , 7 )}_{r} , \\ 10 {log}_{10} ( \frac{{‖ {H}_{k} {V}_{k , i} ‖}^{2}}{{P}_{N , i}} ) is the SNR for the i - th stream and the k - th subcarrier , and {SNR}_{i} is the average SNR for the i - th stream , which may be calculated by 10 {log}_{10} ( \frac{{‖ {H}_{k} {V}_{k , i} ‖}^{2}}{{P}_{N , i}} ) .\end{matrix} \qquad [ Equation 1 ]$$

S̅N̅R̅ᵢ may be expressed as an 8-bit combination in the range of [−128, 127] as shown in Table 3 below, and the delta SNR value may be expressed as a 4-bit combination in the range of [−8, 7]. In other words, the delta SNR may be quantized to the range [−8, 7] through Equation 1.

−8 and 7, which correspond to the max and min operators of Equation 1 are a quantization range, and may be set according to b_{Δsnr} which is the number of quantization bits. Therefore, the quantization range defined in Equation 1 is merely an example, and embodiments of the present application are not limited thereto.

TABLE 3

| Average SNR of space-time stream, i | AvgSNRᵢ | |
|---|---|---|
| −128 | ≤−10 | dB |
| −127 | −9.75 | dB |
| −126 | −9.5 | dB |
| . . . | . . . | |
| +126 | 53.5 | dB |
| +127 | ≥53.75 | dB |

The beamformee may feedback the delta SNR for each stream for each specified subcarrier.

The EHT CQI report field includes EHT CQI report information. The average SNR per a resource unit (RU) of each spatial stream may be transmitted through the EHT CQI report field.

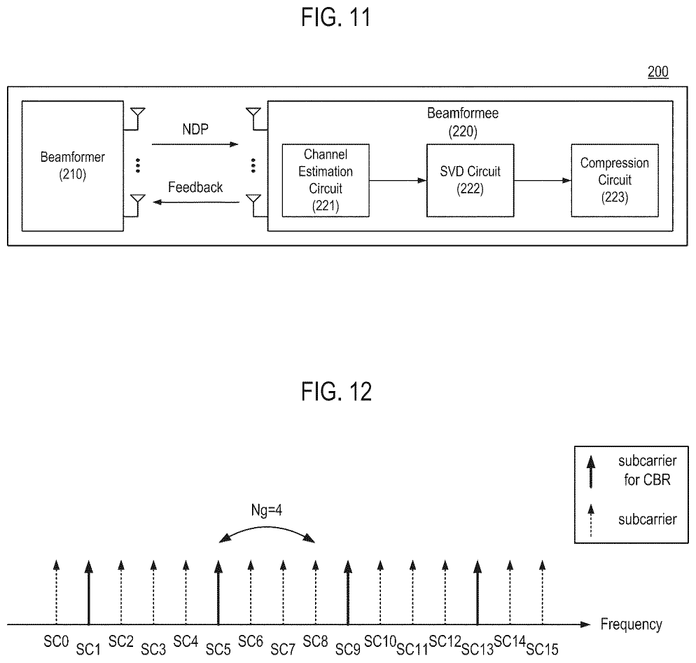

FIG. 11 illustrates a WLAN beamforming system.

Referring to FIG. 11, a WLAN beamforming system 200 may include a beamformer 210 and/or a beamformee 220.

The beamformer may transmit the NDPA frame described above through multiple antennas and then transmit the NDP to the beamformee 220.

The beamformee 220 may receive the NDP through multiple antennas and generate feedback information based on the NDP. The beamformee 220 may include a channel estimation circuit 221, a singular value decomposition (SVD) circuit 222, and/or a compression circuit 223 to generate the feedback information.

The channel estimation circuit 221 may be configured to estimate a channel through which a signal is transmitted and received between the beamformer 210 and the beamformee 220. When the transmission signal is defined as ‘S’, the channel as ‘H’, the reception signal as ‘Y’, and the noise as ‘N’, the relationship between the transmission signal and the reception signal may be defined as in the following Equation 2.

$$Y [ k ] = H [ k ] S [ k ] + N [ k ] \qquad [ Equation 2 ]$$

Where ‘k’ is the index of the subcarrier. Hereinafter, F[k] is defined as a vector ‘F’ or a matrix ‘F’ associated with the k-th subcarrier, and may be conveniently referred to as ‘F’.

In addition, when Ntx and Nrx are defined as the number of transmitting antennas and the number of receiving antennas, respectively, ‘S’ may be defined as a vector having a size of Ntx×1, and ‘H’ may be defined as a matrix having a size of Nrx x Ntx.

A channel estimator may estimate channel ‘H’ based on the NDP. In Equation 2, the NDP may be understood as ‘Y’.

The SVD circuit 222 may perform singular value decomposition (SVD) on a channel estimated by the channel estimator. For example, a singular value decomposition equation for the estimated channel may be defined as in following Equation 3.

$$H [ k ] = U [ k ] \sum [ k ] {V [ k ]}^{H} \qquad [ Equation 3 ]$$

Where ‘U’ and V^{H} are unitary matrices and are defined as the left unitary matrix and the right unitary matrix, respectively. The V^{H} is the Hermetite transpose matrix of ‘V’. ‘V’ may be understood as including information on the transmitting antenna side. ‘Σ’ is a diagonal matrix including channel singular values. Therefore, for optimal (or improved) beamforming, the beamformee 220 may transmit ‘V’ as feedback information to the beamformer 210. Hereinafter, ‘V’ is defined as a beamforming feedback matrix used for beamforming. However, when ‘V’ is transmitted as it is, the feedback overhead may be significant.

The SVD circuit 222 may perform various compression operations on the beamforming feedback matrix. In detail, the SVD circuit 222 may perform a common-phase shift for the beamforming feedback matrix. The SVD circuit 222 may calculate a phase-shifted matrix Q by multiplying the beamforming feedback matrix by the diagonal matrix \tilde{D} for common-phase shift as shown in following Equation 4.

$$Q [ k ] = V [ k ] \tilde{D} \qquad [ Equation 4 ]$$

Where the diagonal matrix \tilde{D} may be defined as

$$\tilde{D} ( {e}^{- j ϕ {N}_{t} - 1} , … , {e}^{- j ϕ {N}_{t - 1} {N}_{t - 1}} )$$

having e^{-jϕ}^{_{i,j}} as an element, the Nt is the row size of the beamforming feedback matrix, which may correspond to the number of transmitting antennas, and the e^{-jϕ}^{_{i,j}} may be defined as the phase value corresponding to the element of the i-th row and j-th column of the beamforming feedback matrix. For example, the

$${e}^{- j ϕ {N}_{t} - 1}$$

is the phase value of the element corresponding to the Nt-th row and 1st column of the beamforming feedback matrix ‘V’. The element corresponding to the last row of each column of the phase-shifted matrix has a real value.

The compression circuit 223 may compress the phase-shifted matrix ‘Q’ calculated by the SVD circuit 222 through Givens rotation. For example, the compression may be performed through Equations 5 to 7.

$$Q [ k ] = [ {\prod }_{i = 1}^{min ( {N}_{r} , {N}_{t} - 1 )} [ {D}_{i} ( {1}_{i - 1} , {e}^{- j ϕ {N}_{ti}} , … , {e}^{- j ϕ {N}_{t - 1} - t} , 1 ) {G}_{li}^{T} ( {ψ}_{li} ) ] {{I}^{⌣}}_{N t \times Nr} \qquad [ Equation 5 ]$$

Where 1ᵢ₋₁ is a vector of 1s of length i−1,

$${G}_{li}^{T} ( {ψ}_{li} )$$

is the Hermitian transpose matrix of Givens rotation matrix Gₗᵢ(ψ), and Ǐ_{Nt×Nr} is an equivalent matrix of size Nt×Nr, and Nr is the column size of the beamforming feedback matrix (e.g., the number of receive antennas).

In Equation 5,

$${D}_{i} ( {1}_{i - 1} , {e}^{\text{?}} , … , {e}^{\text{?}} , 1 )$$

$$\text{?} \text{indicates text missing or illegible when filed}$$

may be defined as a diagonal matrix as in following Equation 6.

$${D}_{i} ( {1}_{i - 1} , e \text{?} … , e \text{?} , 1 ) = [ \begin{matrix}{i}_{i - 1} & 0 & … & … & & 0 \\ 0 & e \text{?} & 0 & … & & 0 \\ ⋮ & 0 & ⋱ & 0 & & 0 \\ ⋮ & ⋮ & & e \text{?} & 0 & \\ 0 & 0 & 0 & 0 & & 1\end{matrix} ] \qquad [ Equation 6 ]$$

$$\text{?} \text{indicates text missing or illegible when filed}$$

In addition, the Givens rotation matrix Gₗᵢ(ψ) in Equation 5 may be defined as in following Equation 7.

$${G}_{li} ( ψ ) = [ \begin{matrix}{I}_{i - 1} & 0 & 0 & … & 0 \\ 0 & cos ( ψ ) & 0 & sin ( ψ ) & 0 \\ 0 & 0 & {I}_{l - i - 1} & 0 & 0 \\ 0 & - sin ( ψ ) & 0 & cos ( ψ ) & 0 \\ 0 & 0 & 0 & 0 & {I}_{Nt - 1}\end{matrix} ] \qquad [ Equation 7 ]$$

The compression circuit 223 may obtain the first angle and the second angle, which are angle information, through compression of the phase-shifted matrix Q.

The compression circuit 223 may quantize the acquired angle information. The compression circuit 223 may quantize the first angle in a bit size of b_{ϕ} and the second angle in a bit size of b_{ψ}. For example, the compression circuit 223 may quantize the first angle based on following Equation 8, and may quantize the second angle based on Equation 8.

$${\hat{ϕ}}_{ji}^{( k )} = \frac{n π}{{2}^{{b}_{ϕ} - 1}} + \frac{π}{{2}^{{b}_{ϕ}}} , n = 1 , 2 , … , {2}^{{b}_{ϕ} - 1} \qquad [ Equation 8 ]$$

$${\hat{ψ}}_{ji}^{( k )} = \frac{n π}{{2}^{{b}_{ψ} - 1}} + \frac{π}{{2}^{{b}_{ψ}}} , n = 1 , 2 , … , {2}^{{b}_{ψ} - 1} \qquad [ Equation 9 ]$$

Where

$${\hat{ϕ}}_{ji}^{( k )}$$

is the quantized first angle and

$${\hat{ψ}}_{ji}^{( k )}$$

is the quantized second angle. The quantized first angle has a value in the range of 0 to 2π, and the quantized second angle has a value in the range of 0 to π/2.

The codebook size (b_{ϕ}, b_{ψ}) for the first and second angles for quantization may be defined according to SU or MU as shown in Table 4.

TABLE 4

| | |
|---|---|
| SU | MU |

| | Coarse | Fine | Coarse | Fine |
|---|---|---|---|---|
| {b_{ψ}, b_{ϕ}} | Codebook | Codebook | Codebook | Codebook |
| 11ac/ax/be | {2, 4} | {4, 6} | {5, 7} | {7, 9} |

As shown in Table 4, in the IEEE 802.11ac/ax/be standard, the codebook size for a rough codebook is defined as {2, 4} for beamforming for a single user, and the codebook size for a precise codebook is defined as {4, 6}. For beamforming for multiple users, the codebook size for the rough codebook is defined as {5, 7}, and the codebook size for the precise codebook is defined as {7, 9}.

In an EHT trigger-based sounding sequence, the STA Info field within the NDPA frame requesting SU or MU feedback may be identified and used by the beamformee 220 to generate SU or MU feedback. In other words, the beamformer 210 may specify the grouping, Ng, codebook size, and/or number of columns of the beamforming feedback matrix to be used by the beamformer 210 through the STA Info field. Then, the beamformee 220 may quantize and feedback channel information (e.g., angle information) based on the indicated parameters.

In an EHT non-trigger-based sounding sequence, the STA Info field in the EHT NDPA frame may request SU feedback. In this case, the beamformee 220 may determine the grouping, Ng, codebook size, and/or number of columns of the beamforming feedback matrix by itself.

According to embodiments described above, the beamformee 220 may estimate a channel through the channel estimation circuit 221, obtain a beamforming feedback matrix through singular value decomposition from the estimated channel, obtain angle information (first angle and second angle) through compression of the beamforming feedback matrix, and quantize the angle information. The beamformee 220 may feedback the quantized angle information to the beamformer 210 as the channel information.

Hereinafter, embodiments for reducing the overhead of the information fed back when feedbacking channel information (e.g., angle information and delta SNR) estimated through channel estimation according to the above-described examples will be described. Specifically, an STA (e.g., a beamformee) may be configured to perform encoding using artificial intelligence (AI) to reduce the overhead of feedback information. Hereinafter, AI-based encoding may be referred to as auto-encoding.

In addition, the channel information (or feedback information) to which AI-based encoding is applied may include at least one of the angle information (first angle and second angle) and delta SNR described above. In some cases, the channel information may include various channel-related information such as an average SNR, which may be reported to an AP, in addition to the angle information and delta SNR. That is, hereinafter, the delta SNR may be replaced with the average SNR, or the delta SNR and average SNR.

The angle information and delta SNR may be measured or estimated for each subcarrier. Hereinafter, the first angle for the k-th subcarrier may be defined as ϕₖ, the second angle may be defined as ψₖ, and the delta SNR may be defined as ΔSNRₖ. In addition, the channel information to be described below may be defined as compressed and quantized through a compression circuit. For example, compression and quantization of angular information may be performed based on Equations 5 to 9 described above.

FIG. 12 illustrates subcarrier grouping.

Referring to FIG. 12, in subcarrier grouping, the beamformee may feedback channel information (e.g., angle information described above) for only some subcarriers, rather than for all subcarriers. The subcarrier grouping may be performed based on Ng, which is a grouping value for subcarrier grouping.

The Ng value is a grouping value indicating a feedback unit of channel information. The Ng value may be determined in the beamformer or the beamformee. For example, the beamformer may indicate the Ng value to the beamformee through the STA Info field in the NDPA frame. Alternatively, beamformee may determine the Ng value in the EHT non-trigger based sounding sequence by itself. For example, in multi-user beamforming, the Ng value may be specified through the beamformer, and in single-user beamforming, the Ng value may be determined through the beamformee.

Once the Ng value is determined, the beamformee feeds back the channel information corresponding to one subcarrier among Ng consecutive subcarriers. In other words, the beamformee may only report a single compressed beamforming feedback matrix for each group of Ng consecutive subcarriers. For example, when the Ng value is determined to be ‘4’ as in FIG. 12, the beamformee may feedback channel information in units of 4 subcarriers.

For example, in FIG. 12, the beamformee may feedback channel information for each of the SC1, SC5, SC9, and SC13 subcarriers among the SC0 to SC15 subcarriers.

The Ng value may be defined according to the IEEE 802.11 standard. For example, in 802.11ac, the Ng value may be defined as 1, 2 and 4, and in 802.11ax/be, the Ng value may be defined as 4 and 16. When the Ng value is 1, the beamformee may feedback channel information for all subcarriers.

Hereinafter, embodiments for reducing the overhead of the information fed back when feedbacking channel information (e.g., angle information and delta SNR) estimated through channel estimation according to the above-described examples to the AP will be described. Specifically, an STA (e.g., a beamformee) may be configured to perform encoding using artificial intelligence (AI) to reduce the overhead of feedback information. Hereinafter, AI-based encoding may be referred to as auto-encoding.

In addition, the channel information (or feedback information) to which AI-based encoding is applied may include at least one of the angle information (first angle and second angle) and delta SNR described above. In some cases, the channel information may include various channel-related information such as an average SNR, which may be reported to an AP, in addition to the angle information and delta SNR.

The angle information and delta SNR may be measured or estimated for each subcarrier. Hereinafter, the first angle for the k-th subcarrier may be defined as ϕₖ, the second angle may be defined as ψₖ, and the delta SNR may be defined as ΔSNRₖ. In addition, the channel information to be described below may be defined as compressed and quantized through a compression circuit. For example, compression and quantization of angular information may be performed based on Equations 5 to 9 described above.

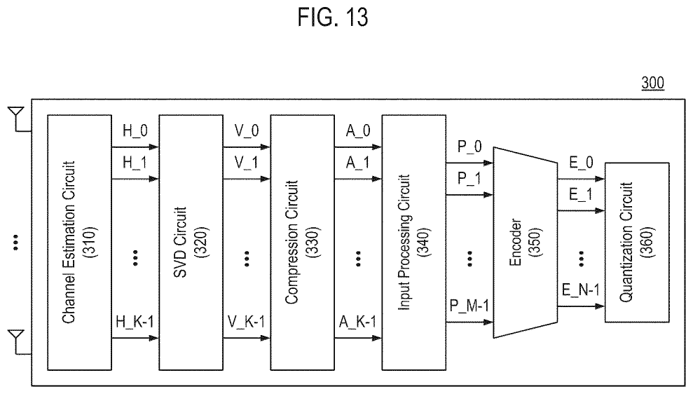

FIG. 13 illustrates an STA according to embodiments.

Referring to FIG. 13, an STA 300 according to embodiments may further include an input processing circuit 340, an encoder 350, and/or a quantization circuit 360 in addition to a channel estimation circuit 310, an SVD circuit 320, and/or a compression circuit 330 according to the above-described examples (e.g., FIG. 11). According to embodiments, the channel estimation circuit 310, the SVD circuit 320, and/or the compression circuit 330 may be the same as or similar to the channel estimation circuit 221, the SVD circuit 222, and/or the compression circuit 223, respectively.

The channel estimation circuit 310 according to embodiments may estimate a channel from a sounding NDP received from an AP and provide ‘K’ estimated channels (H_0 to H_K−1) to the SVD circuit 320. In this case, ‘K’ may be defined as the size of the channel information, which is the number of subcarriers over which the channel is estimated and/or the number of subcarriers over which the channel information is transmitted. That is, the estimated channel may be estimated for each of the ‘K’ subcarriers.

The SVD circuit 320 may obtain ‘K’ beamforming feedback matrices (V_0 to V_K−1) through SVD for ‘K’ estimated channels (H_0 to H_K−1), and provide the obtained ‘K’ beamforming feedback matrices (V_0 to V_K−1) to the compression circuit 330.

The compression circuit 330 may be configured to obtain ‘K’ pieces of angle information (A_0 to A_K−1), which are channel information, through compression and quantization for ‘K’ beamforming feedback matrices (V_0 to V_K−1). In more detail, the angle information may include a first angle and a second angle, and ‘K’ may be defined for each angle. For example, through compression, K1 first angles (where K1 is the number of subcarriers over which the first angle is estimated and/or the number of subcarriers over which the first angle is transmitted) may be generated. In addition, through compression, K2 second angles (where K2 is the number of subcarriers over which the second angle is estimated and/or the number of subcarriers over which the second angle is transmitted) may be generated. K1 and K2 may be the same (or similar) or different and may be determined through the codebook size described above. However, for convenience of explanation, FIG. 13 refers to the number of angle information (e.g., the quantity of pieces of angle information) as ‘K’.

In addition, the channel estimation circuit 310, the SVD circuit 320, and the compression circuit 330 may be configured or operated according to the examples described above, and detailed descriptions of the corresponding circuits will be omitted below.

The input processing circuit 340 may be configured to process channel information such that the channel information is input to the encoder 350. According to embodiments, the input processing circuit 340 may adjust the size of the channel information or perform preprocessing (or processing) on the channel information.

The input processing circuit 340 according to embodiments may convert the size of the channel information to correspond to the size of the input layer of the encoder 350 configured for encoding the channel information. That is, the input processing circuit 340 may reshape the size of the channel information such that the channel information is input to the encoder 350. The size reshaping may include expansion and/or reduction.

First, the encoder 350 may be configured with an AI model to encode channel information to reduce the overhead of channel information feedback. For example, the encoder 350 may include a neural network including an input layer, one or more intermediate layers, and/or an output layer. The size of the input layer may be defined as ‘M’ (where ‘M’ is a natural number). ‘M’ may be defined as the number of nodes included in the input layer.

The encoder 350 may be trained to encode channel information, which is input data input to the encoder 350, through machine learning. The encoder 350 that has completed learning may encode and output channel information to reduce the overhead of feedback on the beamformee side.

The size of the channel information input to the encoder 350 may vary depending on the type of channel information (e.g., angle information, delta SNR, or the like). When the original information is input to the encoder 350 as it is without adjusting the size of the channel information, channel information that does not match the size of the input layer may exist. To encode unmatched channel information, the encoder 350 may be configured for each of channel information. For example, each of the encoders 350 having input layers with different sizes (or numbers of nodes) according to the size of the channel information may be configured for each of channel information.

The input processing circuit 340 according to embodiments may adjust the size of the channel information in order to use the encoder 350 that is commonly configured for all channel information. First, the input processing circuit 340 may compare the size of the angle information, which is channel information, with the size of the input layer. When the size of the channel information and the size of the input layer are the same (or similar), reshaping is not performed. That is, the channel information may be input as it is into the encoder 350.

When the size of the channel information is greater than the size of the input layer, the input processing circuit 340 may reduce the size of the channel information. The input processing circuit 340 according to embodiments may divide the channel information into ‘L’ groups (where ‘L’ is a natural number) based on the size of the channel information being greater than the size of the input layer.

The ‘L’ may be defined as ┌K/M┐. That is, the ‘L’ may be the result of a ceiling function for K/M.

The input processing circuit 340 may perform padding on one group among ‘L’ groups having a size smaller than the size of the input layer. Specifically, the size of the channel information corresponding to the remaining groups except for one group among the ‘L’ groups becomes the same size as (or a similar size to) the size of the input layer through division. One group has a size smaller than the size of the input layer.

Therefore, the input processing circuit 340 may pad the channel information area that is insufficient for the size of the input layer in one group, so that the size of one group may be the same as (or similar to) the size of the input layer.

When the size of the channel information is smaller than the size of the input layer, the input processing circuit 340 may expand the size of the channel information. The input processing circuit 340 according to embodiments may perform padding on the channel information based on the size of the channel information being smaller than the size of the input layer. In this case, grouping is not required (or otherwise, implemented) because the channel information may be resized by padding the insufficient area.

Therefore, the input processing circuit 340 may make the size of the channel information the same as (or similar to) the size of the input layer by padding the channel information area that is insufficient for the size of the input layer in the current channel information.

For example, in the examples described above, the padding may be zero-padding that fills the area to which the padding is applied with 0. Alternatively, the input processing circuit 340 may perform padding based on an arbitrary (or otherwise, given) non-zero real value.

Through the input processing circuit 340 according to the examples described above, it is possible to employ the one common encoder 350 regardless of the type of channel information (e.g., first angle and second angle). In other words, the encoder 350 may be commonly configured for angle information.

The input processing circuit 340 according to embodiments may perform preprocessing (or processing) on the channel information. For example, the preprocessing (or processing) may include normalization.

In detail, the input processing circuit 340 may perform preprocessing (or processing) before inputting the channel information with an adjusted size to the encoder 350 in order to improve the machine learning performance of the encoder 350. For example, the input processing circuit 340 may normalize angle information based on following Equations 10 to 11.

$$f ( {ϕ}_{k} ) = \frac{( {ϕ}_{k} )}{{2}^{{b}_{ϕ}}} \qquad [ Equation 10 ]$$

$$f ( {ψ}_{k} ) = \frac{( {ψ}_{k} )}{{2}^{{b}_{ψ}}} \qquad \text{?}$$

$$\text{?} \text{indicates text missing or illegible when filed}$$

ization function and [symbol] (⋅) is a quantization function. That is, the input processing circuit 340 may normalize the quantized angle information to a range between ‘0 (zero)’ and ‘1’ based on the codebook size (b_{ϕ}, b_{ψ}). Accordingly, the, data amount of the angle information may be reduced.

The input processing circuit 340 may provide ‘M’ processed angle information P_0 to P_M−1 to the encoder 350 through size adjustment and/or preprocessing (or processing) of channel information for ‘K’ angle information A_0 to A_K−1.

The encoder 350 may encode ‘M’ processed angle information P_0 to P_M−1 and provide ‘N’ encoded angle information (where ‘N’ is a natural number) to the quantization circuit 360 through encoding.

The quantization circuit 360 may quantize ‘N’ encoded angle information E_0 to E_N−1. For example, the quantization circuit 360 may quantize the encoded angle information based on \tilde{b}_{ϕ} and \tilde{b}_{ψ}, which are codebook sizes defined for quantization of the encoded angle information. For convenience, when b_{ϕ} and b_{ψ} are defined as the first codebook size and \tilde{b}_{ϕ} and \tilde{b}_{ψ} are defined as the second codebook size, the first codebook size may be used for quantization of angle information before encoding, and the second codebook size may be used for quantization of angle information after encoding.

The STA 300 may feedback the encoded angle information acquired according to the examples described above to an AP.

FIG. 14 illustrates the encoder of FIG. 13 according to embodiments.

Referring to FIG. 14, the encoder 350 according to embodiments may be configured with a neural network including an input layer IL, an intermediate layer ML, and/or an output layer OL. In FIG. 14, the encoder 350 having one intermediate layer ML is illustrated for convenience of explanation, but embodiments of the present application are not limited thereto, and the plurality of intermediate layers ML may be included therein.

When the number of nodes in the input layer IL is ‘M’, the size of the input layer IL is defined as ‘M’. Therefore, the number of data input to the input layer IL is also ‘M’. In this case, the input data P_0 to P_M−1 may be angle information a size of which has been adjusted according to embodiments described above, or angle information a size of which has been adjusted and normalized.

The number of nodes included in the intermediate layer ML and the output layer OL may vary. When the number of nodes included in the output layer OL is ‘N’, the number of encoded angle information E_0 to E_N−1 output through the encoder 350 is ‘N’.

The encoder 350 according to embodiments may be commonly configured for angular information. In addition, the encoder 350 may be commonly configured for the bandwidth and grouping values of the sounding NDP. In other words, the encoder 350 is configured identically (or similarly) even when the angle information, bandwidth and/or grouping values are changed. For example, the same encoder 350 (or similar encoders 350) may be configured for both cases where the bandwidth is set to 20 MHz or 80 MHz, and the same encoder 350 (or similar encoders 350) may be configured for both cases where the Ng value is set to 4 or 16.

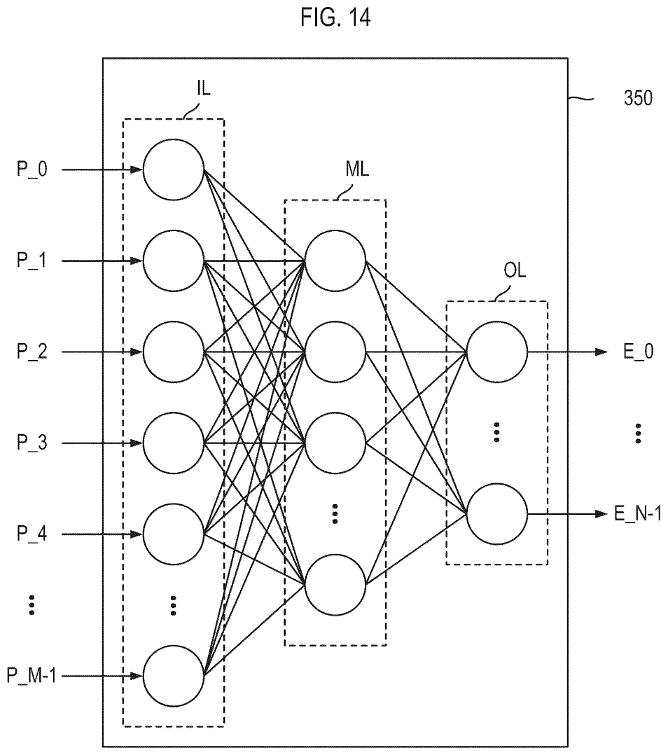

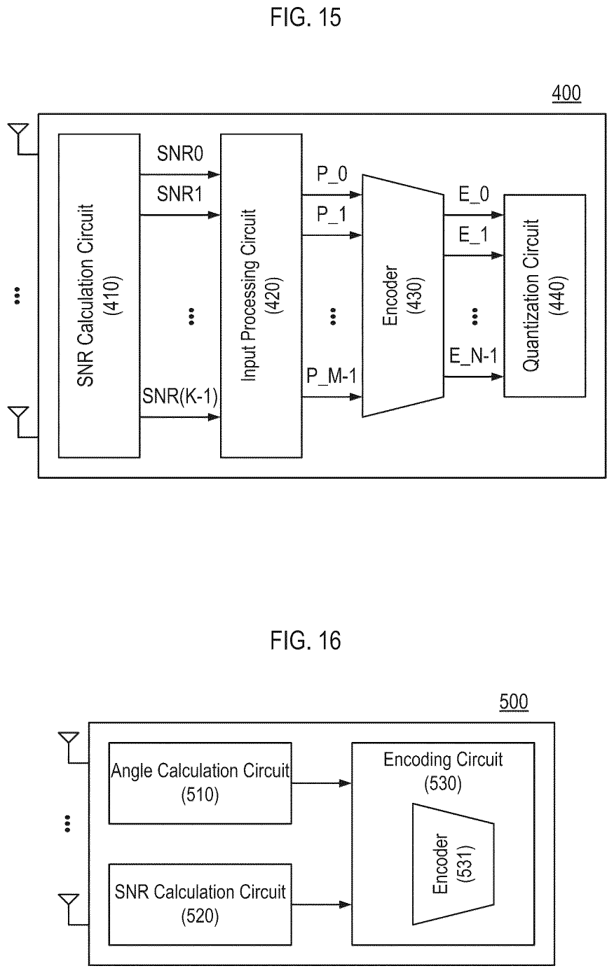

FIG. 15 illustrates an STA according to embodiments.

Referring to FIG. 15, an STA 400 according to embodiments may include an SNR calculation circuit 410, an input processing circuit 420, an encoder 430, and/or a quantization circuit 440. According to embodiments, the input processing circuit 420, the encoder 430 and/or the quantization circuit 440 may be the same as or similar to the input processing circuit 340, the encoder 350 and/or the quantization circuit 360, respectively.

The SNR calculation circuit 410 may calculate the SNR from the stream received by the STA 400. For example, the SNR calculation circuit 410 may calculate an average SNR from a stream, or calculate a delta SNR for a stream and a subcarrier. Therefore, the delta SNR may be calculated as ‘K’, which is the number of subcarriers for which SNR is calculated, similar to the angle information. Of course, the corresponding ‘K’ may be defined differently for each type of channel information, and in order to distinguish it from angle information, the K3 delta SNRs may be defined as being calculated.

The SNR calculation circuit 410 may quantize the calculated average SNR and/or delta SNR. For example, the calculation and quantization of delta SNR may be performed based on Equation 1 described above. According to embodiments, the quantization range may be set based on b_{Δsnr} which is the number of bits for SNR quantization.

The SNR calculation circuit 410 provides ‘K’ pieces of SNR information SNR0 to SNR (K−1) to the input processing circuit 420. The input processing circuit 420 may convert the size (K) of the SNR information, which is channel information, to correspond to the size ‘M’ of the input layer of the encoder 430 according to the examples described above (e.g., FIG. 13). For example, when ‘K’ is greater than ‘M’, the input processing circuit 420 may divide ‘K’ pieces of SNR information SNR0 to SNR (K−1) into ‘L’ groups and perform padding on one of the ‘L’ groups. Therefore, each of the ‘L’ groups may be transformed such that they may all be input to the input layer.

Alternatively, the input processing circuit 420 may perform padding on the SNR information that is missing from ‘M’ when ‘K’ is smaller than ‘M’. Therefore, ‘K’ pieces of SNR information SNR0 to SNR (K−1) may be expanded to ‘M’ pieces of SNR information.

The input processing circuit 420 according to embodiments may perform preprocessing (or processing) (e.g., normalization) on the reshaped SNR information. For example, the input processing circuit 420 may perform normalization on the reshaped delta SNR information based on following Equation 12.

$$f ( Δ {SNR}_{k} ) = \frac{Δ {SNR}_{k}}{{2}^{b Δ snr}} \qquad [ Equation 12 ]$$

Where f( ) is a normalization function. The input processing circuit 420 may reduce the data amount of SNR information through normalization.

The input processing circuit 420 provides ‘M’ processed SNR information P_0 to P_M−1 to the encoder 430, and the encoder 430 encodes the SNR data whose size has been reshaped or preprocessed (or processed) through the input processing circuit 420. The encoder 430 provides ‘N’ encoded SNR data E_0 to E_M−1 to the quantization circuit 440, and the quantization circuit 440 may quantize the encoded SNR data.

The STA 400 may feedback quantized SNR data to the AP as feedback information.

The STA 400 according to the above-described examples may encode channel information through one encoder 430 by converting the size of SNR data to match the size of the input layer of the encoder 430.

FIG. 16 illustrates an STA according to embodiments.

Referring to FIG. 16, an STA 500 according to embodiments may include an encoding circuit 530 including configurations for encoding according to the above-described examples (e.g., an input processing circuit, an encoder, and a quantization circuit of FIGS. 13 and 15) that may be commonly configured for angle information, which is channel information, and SNR. That is, the STA 500 may include one encoding circuit 530 that is commonly configured for an angle calculation circuit 510 including configurations for obtaining angle information (e.g., a channel estimation circuit, an SVD circuit, and a compression circuit of FIG. 13) and an SNR calculation circuit 520 (e.g., FIG. 15).

The encoding circuit 530 may receive K1 first angles and K2 second angles from the angle calculation circuit 510, and/or may receive K3 SNR information (e.g., delta SNR) from the SNR calculation circuit 520. The encoding circuit 530 may compare K1 to K3 with the size M of the input layer of the encoder, and may expand or reduce the size of the angle information and/or delta SNR according to the comparison result. The encoding circuit 530 may encode channel information having an adjusted size through an encoder. In this case, one encoder may be commonly configured for all channel information, bandwidth of sounding NDP, and grouping values.

The encoding circuit 530 may quantize encoded channel information through an encoder 531.

The STA 500 may finally feedback the encoded channel information to an AP.

The STA 500 according to the above-described examples may reduce software/hardware elements for the encoder and the optimization (or improvement) process required (or otherwise, used) for machine learning by configuring only one encoder in common rather than configuring encoders separately for each type, bandwidth, and grouping value of channel information. In addition, the configuration of a single encoder may be possible through processing of channel information (e.g., reshaping and preprocessing (or processing)).

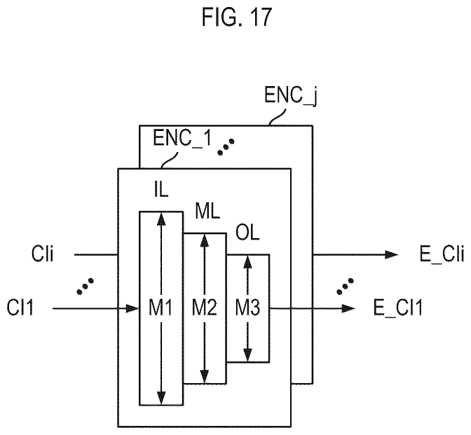

FIG. 17 illustrates an encoder according to embodiments.

Referring to FIG. 17, the encoder according to the examples described above (e.g., those in FIG. 13, FIG. 15, and FIG. 16) may include multiple encoders ENC_1 to ENC_j instead of being composed of a single encoder as in FIG. 14. An encoder according to embodiments may include multiple encoders for each type of channel information. For example, the encoder (e.g., a separate encoder) may be provided for each of the first angle, the second angle, and the delta SNR included in the channel information.

When the number of channel information CI1 to CIi is ‘i’ (where ‘i’ is a natural number), j encoders ENC_1 to ENC_j (where ‘j’ is a natural number) may be configured. ‘i’ and ‘j’ may be the same (or similar) or different. When i=j, the encoder may be configured for each channel information according to the examples described above. When ‘j’ is less than ‘i’, at least one encoder may be configured for encoding multiple pieces of channel information.

The i channel information CI1 to CIi may be encoded through the j encoders ENC_1 to ENC_j, and i encoded channel information E_CI1 to E_CIi may be output through the j encoders ENC_1 to ENC_j.

The j encoders ENC_1 to ENC_j according to embodiments may be commonly configured or differently configured with respect to the bandwidth and grouping values of the sounding NDP.

Each encoder may include the input layer IL, the one or more intermediate layers ML and/or the output layer OL according to the examples described above. For convenience, the intermediate layer ML is depicted as one, but it is obvious that it may include multiple layers. The number of intermediate layers ML may be set depending on the type of channel information, the bandwidth of the sounding NDP, and/or the grouping value. That is, the j encoders may be composed of the same (or similar) or different numbers of intermediate layers ML. In this case, the AP needs to (or otherwise, may) inform the STA of the number of layers each encoder has for each encoder.

The size of the input layer IL is M1, the size of the intermediate layer ML is M2, and the size of the output layer OL is M3. In this case, M2 may be configured identically (or similarly) or differently for each intermediate layer ML.

The M1, M2, and M3 correspond to the number of nodes in each layer. The M1, M2, and M3 may be set according to the type of channel information, the bandwidth of the sounding NDP, and/or the grouping value. That is, the j encoders may be composed of the same (or similar) or different M1, M2, and/or M3. In this case, the AP needs to (or otherwise, may) inform the STA of the M1, M2, and M3 configured for each encoder.

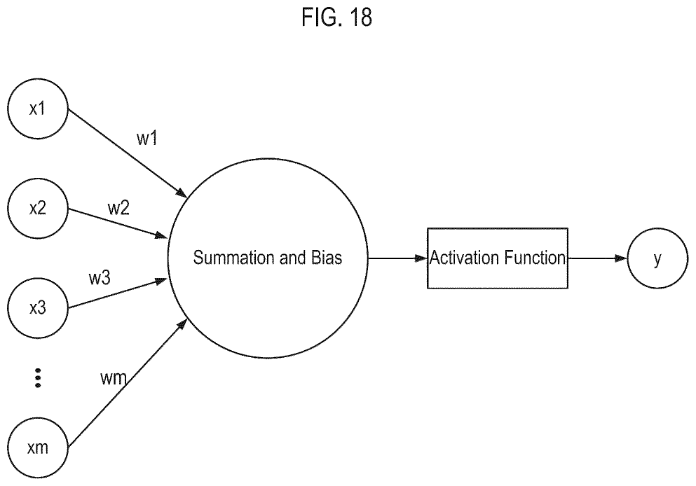

FIG. 18 illustrates a perceptron included in a neural network.

Referring to FIG. 18, a perceptron may correspond to a node included in an encoder according to the examples described above. One perceptron applies summation, bias, and activation function to ‘m’ input data x1 to xm (where ‘m’ is a natural number) and outputs output data y. For each input data, a weight is set or defined.

The summation and bias may be defined as following Equation 13.

$${\sum }_{i = 1}^{m} {w}_{i} {x}_{i} + bias \qquad [ Equation 13 ]$$

In this case, wᵢ is a weight, xᵢ is input data, and bias is a bias value. That is, the input of the activation function is the sum of the product of the weight and the input data and the bias.

The output result of the summation and the bias is input to the activation function, and the output result of the activation function becomes the output data. For example, the activation function may include various nonlinear functions known to those skilled in the art, such as Sigmoid, tanh, ReLU (rectified linear unit), Leaky ReLU, Maxout, and/or ELU (exponential linear unit).

Because the plurality of perceptrons are configured or set in the encoder layer by layer, the STA that encodes channel information through the encoder needs to know (or otherwise, uses) not only the information of the perceptron (e.g., weights, bias values, types of activation functions) for configuring or setting the encoder, but also information related to the neural network of the encoder (e.g., number of layers, number of nodes), channel information to be encoded through the encoder, and the like.

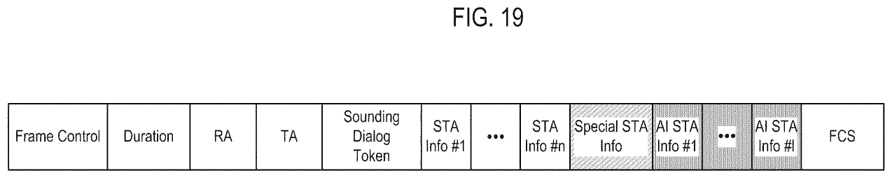

FIG. 19 illustrates the frame structure of an NDPA frame according to embodiments.

Referring to FIG. 19, an NDPA frame according to embodiments may include the frame control field, duration field, RA field, TA field, sounding dialogue token number field, n STA Info fields, and/or FCS field included in the NDPA frame of FIG. 6, and may further include one or more fields associated with the encoder for encoding channel information. The channel information that may be encoded may include angles (first and second angles), delta SNR, and/or CQI included in the compressed beamforming feedback matrix.

One or more fields may include a special STA Info field indicating whether channel information is to be encoded and/or an AI STA Info field(s) for setting the encoder. The special STA Info field and the AI STA Info field(s) may be provided between the sounding dialogue token number field and the FCS field. The special STA Info field may be referred to as the first field, and the AI STA Info field(s) may be referred to as the second field(s).

The AI STA Info field may be configured in multiple numbers, for example, ‘l’ (where ‘l’ is a natural number). When multiple AI STA Info fields are configured, the subfields included in each AI STA Info field may be configured identically (or similarly), but the content indicated by each subfield or the information or data included in each subfield may be different.

According to embodiments, the AI STA Info field may be configured for each station. In this case, the number 1 of AI STA Info fields may be equal to the number of stations for which encoder settings are required (or otherwise, provided). The number l may be equal to or different from the number ‘n’ of STA Info fields. The STA Info field may be allocated and set for each of ‘n’ beamformees that are beamforming targets, but the AI STA Info field may be allocated and set for all beamformees, or may be allocated and set for only some of the beamformees. Therefore, the beamformer may generate (or acquire) and transmit an NDPA frame including an AI STA Info field only for beamformees among the beamformees capable of encoding feedback information or beamformees requested to encode feedback information.

The AI STA Info field may be configured subsequent to the special STA Info field within an NDPA frame. An AP may generate an NDPA frame including a special STA Info field and an AI STA Info field between an STA Info field and a FCS field, and transmit the NDPA frame to the STA. The STA that receives the NDPA frame may identify the type of channel information to be encoded through the special STA Info field and obtain setting information of an encoder to be used for encoding through the AI STA Info field.

The NDPA frame according to embodiments described above may provide backward compatibility with the NDPA frame of existing versions by adding a field related to an encoder to the fields included in the NDPA frame of FIG. 6. In addition, the AP may transmit information associated with an encoder for encoding channel information to be fed back through an STA while including the information in the NDPA frame for notifying the sounding NDP.

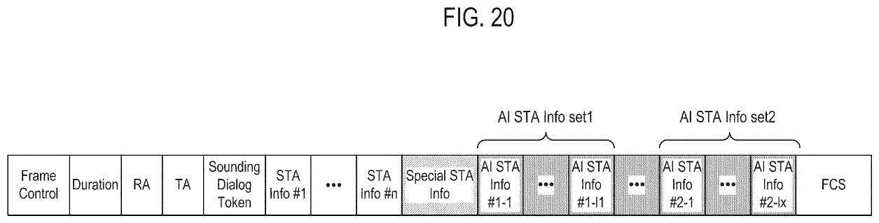

FIG. 20 illustrates the frame structure of an NDPA frame according to embodiments.

When the AI STA Info field for setting the encoder in FIG. 19 defines a plurality of units configured for each station as an AI STA Info set, the NDPA frame of FIG. 20 according to embodiments may include a plurality of AI STA Info sets.

As illustrated, each AI STA Info set may be provided for each station. For example, AI STA Info set 1 may include l1 AI STA Info fields AI STA Info #1-1 to AI STA Info #1-l1 (where l1 is a natural number), and AI STA Info set 2 may include lx AI STA Info fields AI STA Info #2-1 to AI STA Info #2-lx (where lx is a natural number and is the same as (or similar to) or different from l1). In addition, additional AI STA Info sets may be provided between AI STA Info set 1 and AI STA Info set 2.

Each AI STA Info set may include setting information that needs to (or otherwise, may) be differently indicated among the setting information of the encoder. In this case, ‘differently indicated setting information’ may mean that the type of setting information is the same (or similar), but its value is different. For example, information related to the structure of the encoder (e.g., number of layers and number of nodes) or information such as activation function may be common. On the other hand, weight information or bias values may be different depending on the type of input data (e.g., the type of channel information) even when the structure of the encoder is the same (or similar).

Therefore, the AP may include common setting information in all AI STA Info sets and different setting information in each corresponding AI STA Info set.

Alternatively, each AI STA Info set according to embodiments may include only different configuration information. That is, each AI STA Info set may be configured for different encoder settings. The encoder may be configured differently for channel information, STA, bandwidth and/or Ng, and accordingly, each AI STA Info set may also include setting information of the encoder that may be configured differently for channel information, STA, bandwidth and/or Ng.

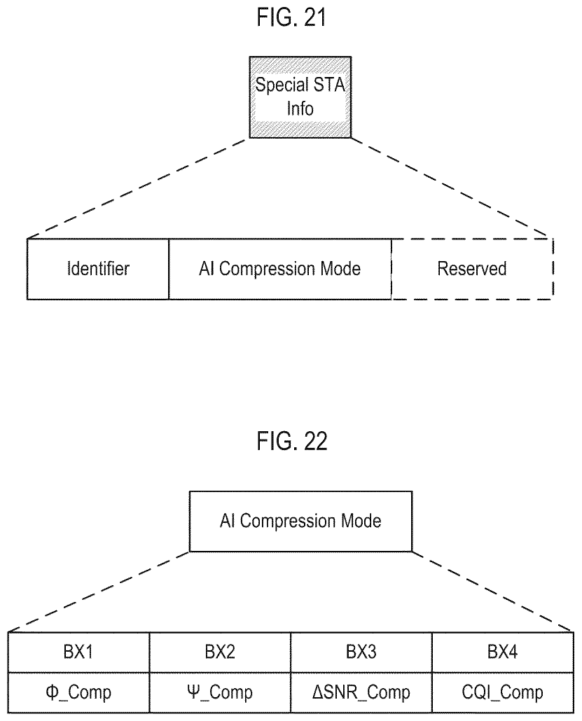

FIG. 21 illustrates subfields of a special STA Info field according to embodiments.

Referring to FIG. 21, a special STA Info field according to embodiments may include an identifier field and an AI compression mode field. In addition, reserved fields may be configured or omitted.

The identifier field is an identifier subfield for identifying the special STA Info field. For example, the identifier field may be an AID11 subfield defined in the IEEE standard. However, unlike the AID11 subfield of the STA Info field, which indicates identifier information of the STA, the identifier field may be used to identify the special STA Info field.

For example, when the identifier field includes an AID11 subfield, the identifier field may have a size of 11 bits. Among the values from 0 to 2047 corresponding to the 11-bit combination, specific values may be used as values identifying the special STA Info field. For example, 2007 or 2008 to 2047 may be used as values identifying the special STA Info field.

The AI compression mode field may indicate the encoding target by type of channel information. According to embodiments, the AI compression mode field may indicate a value representing channel information and/or a combination of channel information to be encoded. Alternatively, the AI compression mode field may explicitly indicate which channel information (e.g., which type of channel information) is to be encoded. According to embodiments, the AI compression mode field may include multiple bits. For example, the AI compression mode field may be configured in a bitmap format. The AI compression mode field may indicate which channel information (e.g., first angle, second angle, delta SNR, CQI, and the like) is the target channel information to be encoded through multiple bits.

Channel information other than the channel information indicated through the AI compression mode field is not encoded by the encoder. Of course, according to the examples described above, the angle information may be compressed through Givens rotation and quantization, and the delta SNR may be quantized in the calculation process (e.g., Equation 1).

FIG. 22 illustrates an AI compression mode field according to embodiments.

Referring to FIG. 22, the AI compression mode field according to embodiments includes a plurality of bits defined for the first angle, second angle, delta SNR, and CQI which are four types of channel information. Each bit may correspond to each type of channel information. For example, the BX1 bit may indicate whether the first angle is an encoding target, BX2 may indicate whether the second angle is an encoding target, BX3 may indicate whether the delta SNR is an encoding target, and BX4 may indicate whether the CQI is an encoding target. When each bit has a specific logic level (e.g., logic high or logic low), the channel information corresponding to the corresponding bit may be encoded.

For example, when the bitmap of BX1 to BX4 represents ‘1100’, the first angle and the second angle become encoding targets. The STA may encode the first angle and the second angle by the encoder through the AI compression mode field. For example, when the bitmap of BX1 to BX4 represents ‘1010’, the first angle and the delta SNR become the encoding targets. The STA may encode the first angle and the delta SNR by the encoder through the AI compression mode field.

FIG. 22 illustrates an AI compression mode field. When channel information that may be a feedback target from the STA side increases, bits corresponding to the increased channel information may be added. To the contrary, when channel information that may be a feedback target is reduced, the bits may be reduced further.

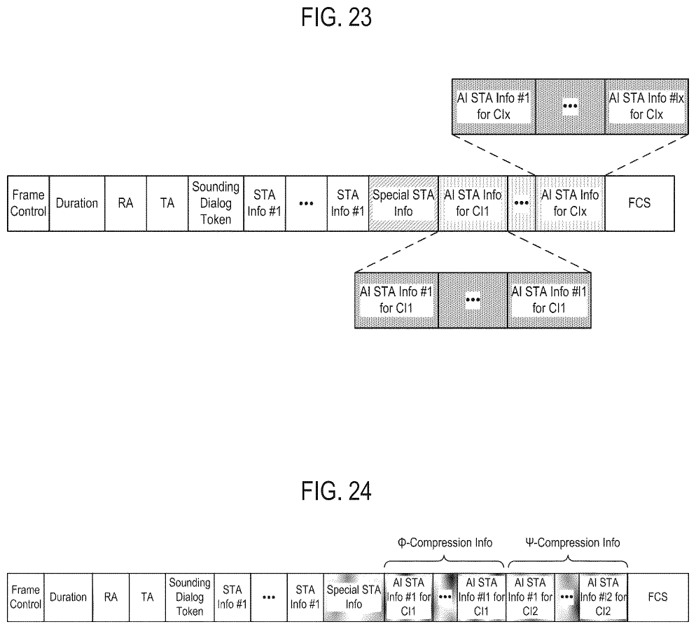

FIG. 23 illustrates the frame structure of an NDPA frame according to embodiments. FIG. 24 illustrates an example of the NDPA frame of FIG. 23.

Referring to FIG. 23, like in FIG. 19, an NDPA frame according to embodiments may include a special STA Info field and an AI STA Info field(s). In this case, the AI STA Info field may be configured for each type of channel information. That is, when multiple encoders are configured for each type of channel information, the AI STA Info field may be configured for each of multiple encoders.

The AI STA Info fields (e.g., AI STA Info for CI1) mapped to the same channel information (or similar channel information) may be regarded as the AI STA Info set in FIG. 20 described above.

For example, when channel information that is a feedback target is defined as first channel information CI1 to the x-th channel information CIx (where x is a natural number) for each type, the AI STA Info field may be configured for each of channel information. In addition, the AI STA Info field for each of channel information may be configured for each station.

The channel information for configuring the AI STA Info field may be indicated through the special STA Info field.

According to embodiments, AI STA Info fields AI STA Info #1 for CI1 to AI STA Info #l1 for CI1 for the first channel information may be configured for l1 stations, and AI STA Info fields AI STA Info #1 for CIx to AI STA Info #lx for CIx for the x-th channel information may be configured for lx stations. The AP may select a station for which the AI STA Info field corresponding to each of channel information is to be configured.

Referring to FIG. 24, for example, when the AP desires to set the first angle and the second angle as encoding targets, the first angle and the second angle may be indicated through the AI compression mode field. In this case, x=2, the first channel information CI1 is the first angle, and the second channel information CI2 is the second angle. The AP may configure AI STA Info fields AI STA Info #1 for CI1 to AI STA Info #l1 for CI1 for the first channel information CI1 for each of l1 stations, and may configure AI STA Info fields AI STA Info #1 for CI2 to AI STA Info #l2 for CI2 for the second channel information CI2 for l2 stations.

According to the examples described above, the AP may efficiently transmit channel information and/or information for setting an encoder for each station through an NDPA frame including an AI STA Info field.

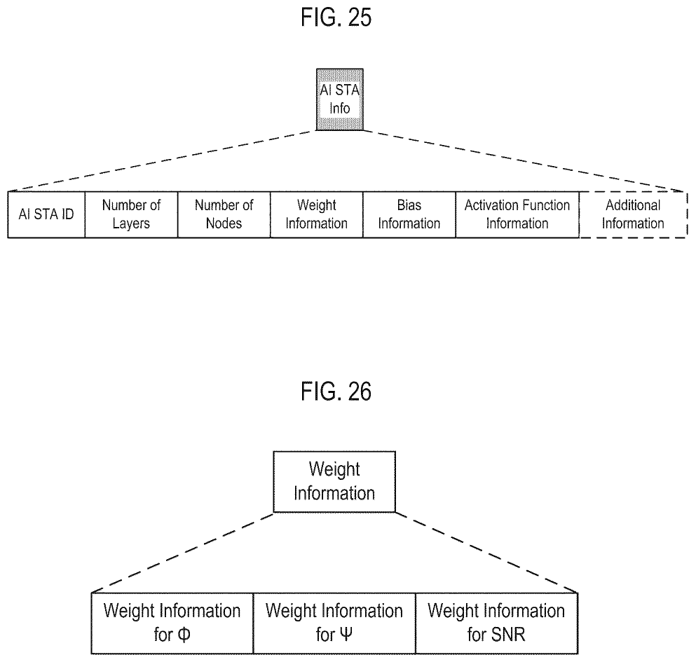

FIG. 25 illustrates subfields of an AI STA Info field according to embodiments. FIG. 26 illustrates an example of the subfield in FIG. 25. The subfields of the AI STA Info field in FIG. 25 may be commonly applied to each AI STA Info field (e.g., FIG. 19, FIG. 20, FIG. 23, and FIG. 24) described above.

Referring to FIG. 25, the AI STA Info field according to embodiments is, which is a field configured for each of the channel information, STA, bandwidth and/or Ng according to the above-described examples, may include an identifier subfield, a layer number subfield, a node number subfield, a weight information subfield, a bias information subfield, and/or an activation function information subfield. In the present application, the identifier subfield, the layer number subfield, the node number subfield, the weight information subfield, the bias information subfield, and/or the activation function information subfield may be sequentially defined or referred to as an AI STA ID subfield, a number-of-layers subfield, a number-of-nodes subfield, a weight information subfield, a bias Information subfield, and/or an activation function information subfield.

The identifier subfield may be configured to identify the STA. The STA may obtain setting information of an encoder to be configured in the corresponding STA through the identifier subfield.

The number of layers subfield may be configured to indicate the number of layers included in the encoder (e.g., FIG. 14). According to embodiments, the number of layers subfield may be configured to indicate the total number of layers included in the encoder, or may be configured to indicate the number for each layer (in particular, the number of intermediate layers). For example, the number of layers subfield may indicate the number of input layers, one or more intermediate layers, and/or an output layer included in the encoder.

The node number subfield may indicate the number of nodes in the encoder. According to embodiments, the node number subfield may be configured to indicate the total number of nodes included in the encoder, or may be configured to indicate the number of nodes of each layer included in the encoder. For example, the node number subfield may sequentially indicate the number of input layers, the number of intermediate layers, and/or the number of output layers.

The weight information subfield may be configured to indicate the weight of the encoder. For example, the weight information subfield may indicate a weight as

$${w}_{ij}^{( l )} ,$$

where ‘l’ is the index of the layer, and ‘i’ and ‘j’ are the indices of the nodes connected to the weight. That is,

$${w}_{ij}^{( l )}$$

may represent the value of the weight defined between node ‘i’ and node ‘j’ in the l-th layer. The weight information subfield may inform about all weights defined for the encoder.

The bias information subfield may be configured to indicate a bias value of the encoder. For example, the bias information subfield may indicate a weight as

$${b}_{i}^{( l )} ,$$

where ‘l’ is the index of the layer and ‘i’ is the index of the node to which the bias value is to be applied. That is,

$${b}_{i}^{( l )}$$

may represent the bias value applied to node ‘i’ in the 1-th layer. The bias information subfield may inform all the weights defined for the encoder.

The activation function information subfield may be configured to indicate an activation function of the encoder.

The AI STA Info field according to embodiments may additionally include an additional information subfield including at least one of a number of quantization bits for the encoded channel information from the encoder or a preprocessing (or processing) function applied to the channel information. That is, the additional information subfield may indicate how many bits are used for quantization of encoded channel information and fed back by the STA, and may also indicate the type of preprocessing (or processing) function to be used before encoding. For example, the preprocessing (or processing) function may include various functions that may be used for preprocessing (or processing) data to be used for encoding, including normalization functions such as mathematical expressions 10 to 12 described above.

The subfields included in the AI STA Info field according to the examples described above may be configured by channel information, STA, bandwidth and/or Ng according to the AI STA Info field that may be configured by channel information, STA, bandwidth and/or Ng. That is, the configuration information of the encoder (e.g., number of layers, number of nodes, weights, bias, and/or activation function) may be indicated through each subfield for each encoder to be configured in the STA corresponding to the identifier subfield. The configuration information of the encoder may be indicated through each subfield for each encoder, which may be configured differently according to channel information, or may be indicated through each subfield for each encoder, which may be configured differently according to bandwidth or Ng.

The weight information subfield according to embodiments may indicate a weight for one channel information (or one piece of channel information), or may indicate weights for multiple channel information (or multiple pieces of channel information). For example, when the AI STA Info field is set for each piece of channel information, the weight information subfield may indicate the weight for one piece channel information. Alternatively, for example, when the AI STA Info field is set for a common encoder for channel information (e.g., the AI STA Info field is set commonly for channel information), the weight information subfield may indicate the weight(s) for all channel information to be encoded.

Referring to FIG. 26, for example, the channel information to be encoded is the first angle and the second angle and the delta SNR included in the compressed beamforming feedback matrix, and the weight information subfield may indicate both the weights for the angles and the weights for the delta SNR.

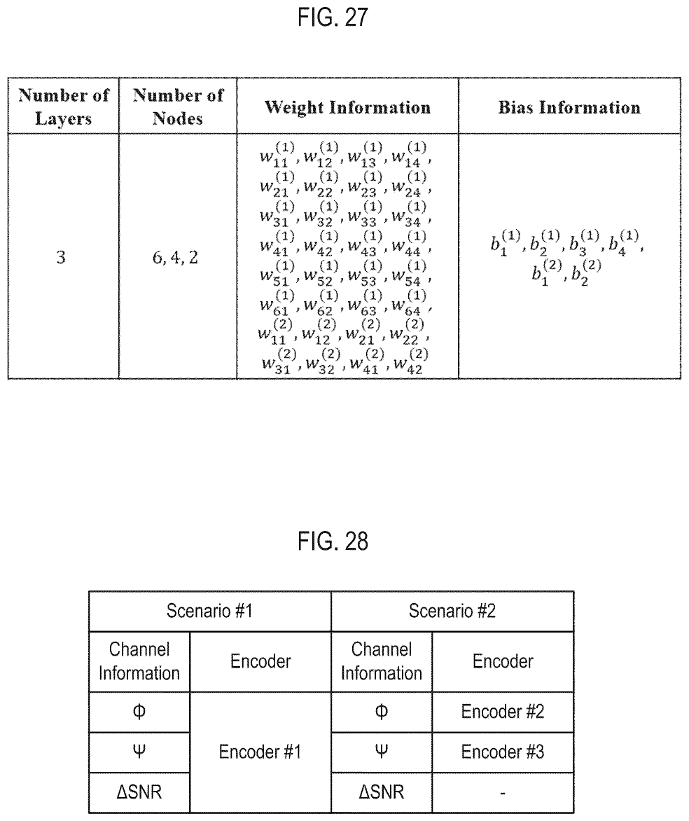

FIG. 27 illustrates some subfields included in the AI STA Info field of FIG. 25 according to embodiments.

Referring to FIG. 27, the number of layers subfield indicates that three layers are configured in the encoder, and the number of nodes subfield indicates the number of nodes (six nodes) included in the input layer, the number of nodes (four nodes) included in the intermediate layer, and the number of nodes (two nodes) included in the output layer. The weight information subfield indicates both the weights between the input layer and the intermediate layer, and the weights between the intermediate layer and the output layer, in the form of

$${w}_{ij}^{( l )} .$$

The bias information subfield indicates the bias values to be applied to the sum value of weights from the nodes of the input layer and the bias values to be applied to the sum value of weights from the nodes of the intermediate layer. According to embodiments, the STA (e.g., the STA 300) may configure an AI model included in an encoder (e.g., the encoder 350) according to the information contained in the AI STA Info field. For example, the STA may allocate a number of layers of the AI model consistent with the number of layers subfield, allocate a number of nodes of each of the layers consistent with the number of nodes subfield, set weights between the layers consistent with the weight information subfield, set the bias values to the nodes consistent with the bias information subfield, and/or set the activation function of the AI model consistent with the activation function information subfield.

With respect to the NDPA frame according to the examples described above, several scenarios may be considered.

FIG. 28 illustrates examples of scenarios related to encoder settings.

Referring to FIG. 28, two scenarios may be considered as examples. In addition, it is assumed that three types of channel information (first angle, second angle, and delta SNR) are the encoding targets.

Scenario 1—Case where Encoders with the Same Structure (or Similar Structures) are Used for Each Type of Channel Information

In scenario 1, the AP wants to inform (or otherwise, informs) the STA of the configuration of a common first encoder for channel information through an NDPA frame.

According to embodiments, the NDPA frame may be configured as in FIG. 19. The AI STA Info field for one STA may indicate the number of layers, the number of nodes, the weights, the bias values, and/or the activation function of the first encoder through the subfields of FIG. 25. When the weights and/or bias values are different for each of the types of channel information, the weight information subfield and/or the bias information subfield may both indicate different weights and/or bias values for each of types of channel information.

According to embodiments, the NDPA frame may be configured as in FIG. 20. When the weights and/or bias values are different for each of the types of channel information, different AI STA Info sets may indicate different weights and/or bias values.

Scenario 2—Case where Encoders with Different Structures are Used for Each Type of Channel Information

In scenario 1, the AP desires to inform (or otherwise, informs) the STA of information for configuring the second encoder for the first angle and the third encoder for the second angle through the NDPA frame.

According to embodiments, the NDPA frame may be configured as in FIG. 19. The AI STA Info field for one STA may indicate the number of layers, the number of nodes, the weights, the bias values, and/or the activation function of the second encoder and the number of layers, the number of nodes, the weights, the bias values, and/or the activation function of the third encoder through the subfields of FIG. 25.

According to embodiments, the NDPA frame may be configured as in FIG. 20. Different AI STA Info sets may indicate setting information for different encoders.

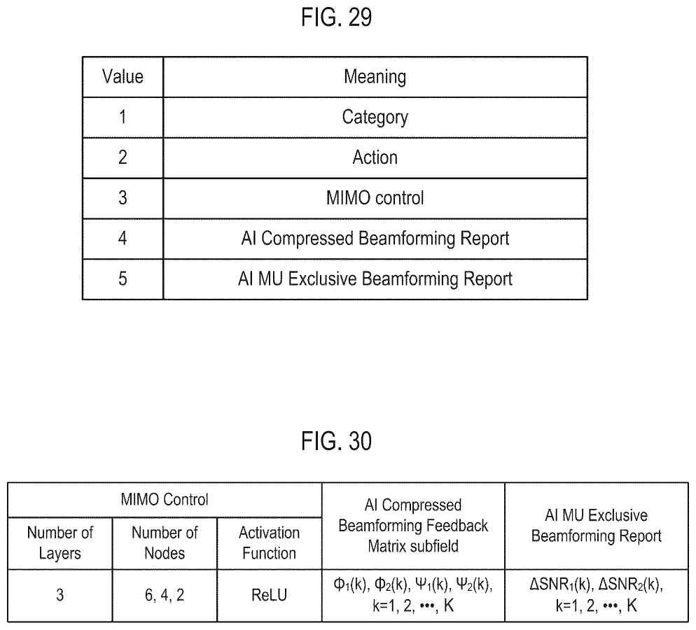

FIG. 29 illustrates a structure of a CBR frame according to embodiments. FIG. 30 illustrates some fields of the CBR frame of FIG. 29.

Referring to FIG. 29, a CBR frame according to embodiments is a frame generated by an STA, and is a frame transmitted to an AP side by the STA that receives an NDPA frame including information associated with an encoder according to the above-described examples. Therefore, unlike the CBR frame of FIG. 9, the CBR frame of FIG. 29 may include information associated with the encoder.

The CBR frame may include, in order, a category field, an action field, a MIMO control field, an AI compressed beamforming report field, and/or an AI MU exclusive beamforming report field.

The category field is set to a value indicating the action field, and the action field is set to a value indicating the AI compressed beamforming report field.

The MIMO control field may include setting information of the encoder. The AI compressed beamforming report field (or beamforming report field) may include encoded channel information (in particular, first angle and second angle). The AI MU exclusive beamforming report field may be included only for MU beamforming and include encoded channel information (in particular, delta SNR).

According to embodiments, the CBR frame may additionally include an AI CQI report field (not shown). The AI CQI report field (not shown) may include encoded CQI information.

Referring to FIG. 30, for example, the MIMO control field may include the number of layers, the number of nodes, and/or an activation function. Each of information may be indicated by the AP through the NDPA frame according to the examples described above, and the STA may feedback through the MIMO control field that the encoder is configured according to the indicated setting information.

For example, the AI compressed beamforming report field may include the first angle and/or second angle encoded for each subcarrier, and/or in case of MU beamforming, the AI MU exclusive beamforming report field may include the delta SNR encoded for each subcarrier.

According to embodiments, the AI compressed beamforming report field and/or the AI MU exclusive beamforming report field may include encoded channel information and unencoded channel information. In this case, the unencoded channel information may be channel information that is not encoded through the encoder, but is compressed (e.g., Givens rotation, and the like) and quantized from the STA.

According to embodiments, the CBR frame may include the EHT compressed beamforming report field, the EHT MU exclusive beamforming report field, and/or the EHT CQI report field of FIG. 9, and the AI compressed beamforming report field and/or the AI MU exclusive beamforming report field.

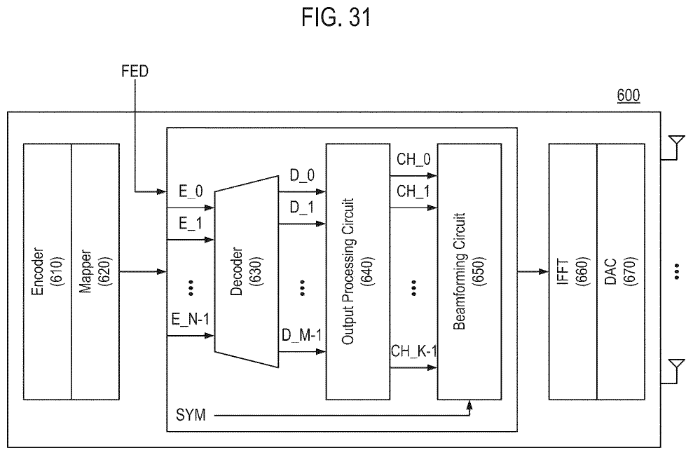

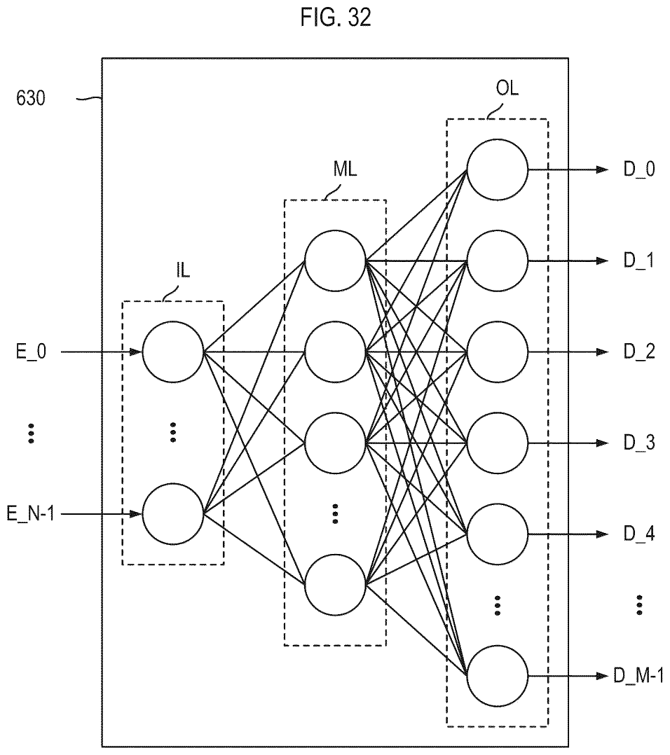

FIG. 31 illustrates an AP according to embodiments. FIG. 32 illustrates a decoder of FIG. 31 according to embodiments.

Referring to FIG. 31, an AP 600 according to embodiments may include an encoder 610, a mapper 620, a decoder 630, an output processing circuit 640, a beamforming circuit 650, an inverse fast Fourier transform (IFFT) 660, and/or a digital-to-analog converter (DAC) 670.

The encoder 610 encodes an input bit sequence and provides the encoded signal to the mapper 620. The mapper 620 may perform constellation mapping and/or spatial mapping on the encoded signal. The mapped symbols may be transmitted to the beamforming circuit 650.

The decoder 630 may be configured to decode ‘N’ encoded channel information E_0 to E_N−1 included in feedback information FED received from the STA. In this case, the encoded channel information E_0 to E_N−1 may be information quantized in the STA.

Referring to FIG. 32, like the encoder (the encoder on the STA side), the decoder 630 may include a neural network including an input layer IL, one or more intermediate layers ML, and/or an output layer OL. In addition, the decoder 630 may have a structure that is symmetrical with respect to the direction in which nodes are arranged in each layer of the encoder 610 according to the examples described above. That is, the output layer OL of the encoder may be configured corresponding to the input layer IL of the decoder 630, and the input layer IL of the encoder may be configured corresponding to the output layer OL of the decoder 630. Therefore, the size of the input layer IL of the decoder 630 is ‘N’, and the size of the output layer OL is ‘M’. The size of each layer may be defined as the number of nodes included in each layer.

The decoder 630 according to embodiments may have a structure symmetrical to the encoder configured according to the setting information indicated to the STA through the NDPA frame by the AP 600 according to the examples described above.

Like the encoder, the decoder 630 may also be trained to decode channel information, which is input data input to the decoder 630, through machine learning. The decoder 630 that completes learning may output ‘M’ decoded channel information D_0 to D_M−1 by decoding the channel information fed back from the beamformee side as it is.

Returning to FIG. 31 again, the output processing circuit 640 may be configured to obtain angle information by post-processing (or processing) the ‘M’ decoded channel information D_0 to D_M−1 provided from the decoder 630.

In this case, post-processing (or processing) may be defined as performing the reverse process of adjusting the size and pre-processing of channel information on the STA side according to the examples described above. That is, the output processing circuit 640 may perform the reverse process of preprocessing on the decoded channel information and the reverse process of reshaping on the result. The reverse process of reshaping may mean transforming the size of the decoded channel information to correspond to the number of subcarriers, ‘M’, over which the channel information is transmitted.

The output processing circuit 640 according to embodiments may perform post-processing based on following Equations 14 to 16.

$${\hat{ϕ}}_{k} = {f}^{- 1} ( {ϕ}_{k} ) \qquad [ Equation 14 ]$$

$${\hat{ψ}}_{k} = {f}^{- 1} ( {ψ}_{k} ) \qquad [ Equation 15 ]$$

$$Δ {k}_{} = {f}^{- 1} ( Δ {SNR}_{k} ) \qquad [ Equation 16 ]$$

Where f⁻¹( ) is the inverse function of the normalization function, \hat{ϕ}ₖ is the post-processed first angle information, \hat{ψ}ₖ is the post-processed second angle information, and [symbol] is the post-processed delta SNR information.

Thereafter, the output processing circuit 640 may obtain ‘K’ pieces of original channel information by removing the padded area from the post-processed channel information. As described above, ‘K’ may be defined according to the channel information. The beamforming circuit 650 may perform beamforming based on obtained

channel information. The beamforming circuit 650 may calculate a steering matrix based on the obtained channel information and replace an existing steering matrix with the calculated steering matrix. Through the steering matrix, optimal (or improved) beamforming for the transmitted signal may be performed.

The IFFT 660 performs inverse Fourier transform on the signal to be transmitted, and the DAC 670 converts the signal to be transmitted into an analog signal.

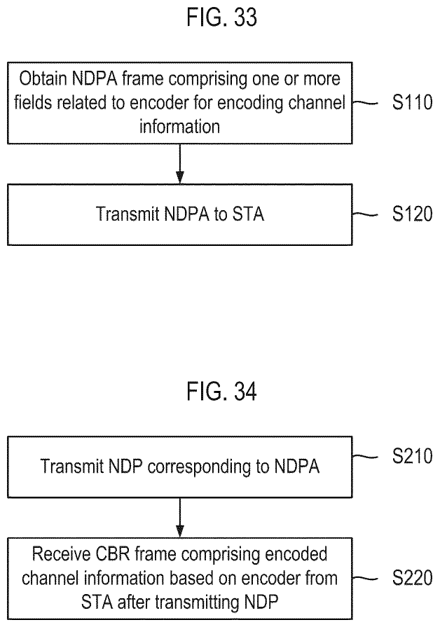

FIG. 33 is a flowchart illustrating an operation method of an AP according to embodiments.

Referring to FIG. 33, in operation S110, the AP may obtain an NDPA frame including one or more fields associated with an encoder for encoding channel information. For example, the AP may generate an NDPA frame that includes a special STA Info field for indicating channel information to be encoded and an AI STA Info field for setting the encoder.

In operation S120, the AP may transmit the obtained NDPA frame to the STA.

Through the operation method according to the examples described above, the AP may efficiently inform the STA of information related to the encoder through the NDPA frame utilized in the sounding sequence.

FIG. 34 is a flowchart illustrating an operation method of an AP according to embodiments.

Referring to FIG. 34, in operation S210, the AP may transmit an NDP corresponding to the NDPA frame. According to embodiments, the AP may additionally transmit a BFRP frame depending on whether the sounding sequence is trigger-based.

In operation S220, the AP may receive a CBR frame including channel information encoded based on an encoder from the STA. In this case, the encoder used for encoding in the STA may be configured according to the setting information indicated by the AP through the NDPA frame. In addition, the encoded channel information included in the CBR frame may be channel information that the AP indicates as an encoding target through the NDPA frame. According to embodiments, the AP may generate a first signal, process the first signal to perform one or more among modulating, upconverting, filtering, amplifying and/or encrypting on the first signal, derive a steering matrix for beamforming the first signal using the encoded channel information, and may transmit the beamformed first signal to the STA. Additionally or alternatively, the AP may receive a second signal from the STA, process the second signal to perform one or more among demodulating, downconverting, filtering, amplifying and/or decrypting on the second signal, and perform a further operation(s) based on the processed second signal. For example, the further operation(s) may include one or more of providing the processed second signal to a corresponding application executing on the AP, storing the processed second signal, sending a response signal to the STA (e.g., based on a processing result of the corresponding application executing on the AP), etc.

Because the feedback information is encoded through the operation method according to embodiments described above, the AP and STA may reduce feedback overhead.

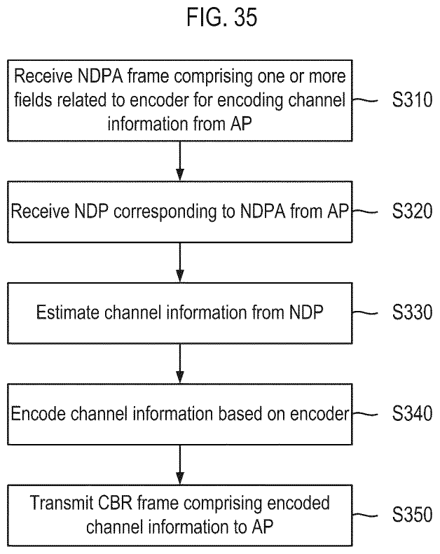

FIG. 35 is a flowchart illustrating an operation method of an STA according to embodiments.

Referring to FIG. 35, in operation S310, the STA may receive an NDPA frame including one or more fields associated with an encoder for encoding channel information from the AP.

In operation S320, the STA may receive the NDP corresponding to the NDPA frame from the AP.

In operation S330, the STA may estimate the channel information from the received NDP.

In operation S340, the STA may encode the channel information based on the encoder. In this case, the encoder used for encoding may be configured through setting information indicated from the NDPA frame.

In operation S350, the STA may transmit a CBR frame including the encoded channel information to the AP. According to embodiments, the STA may receive a first signal from the AP that is beamformed according to the encoded channel information, process the first signal to perform one or more among demodulating, downconverting, filtering, amplifying and/or decrypting on the first signal, and perform a further operation(s) based on the processed first signal. For example, the further operation(s) may include one or more of providing the processed first signal to a corresponding application executing on the STA, storing the processed first signal, sending a response signal to the AP (e.g., based on a processing result of the corresponding application executing on the STA), etc.

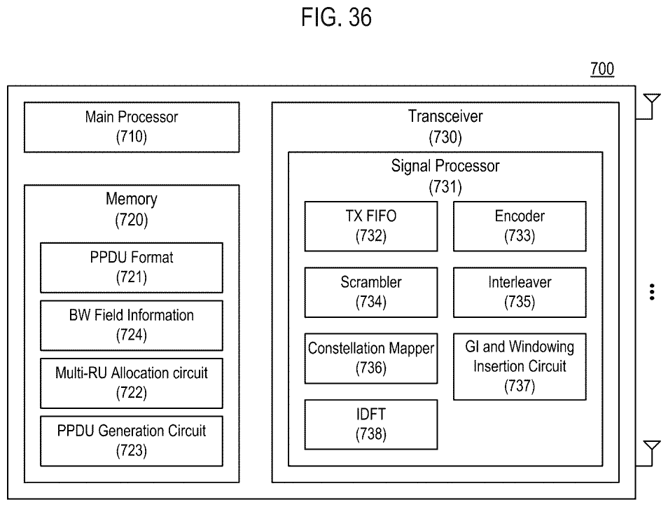

FIG. 36 is a block diagram illustrating a wireless communication device according to embodiments.

Referring to FIG. 36, a wireless communication device 700 may be a transmitting device (e.g., an access point (AP)) or a receiving device (e.g., a station (STA)) including a transceiver capable of data communication. That is, the wireless communication device 700 of FIG. 36 may be one of the access points AP1 and/or AP2 and/or the stations STA1, STA2, STA3 and/or STA4 illustrated in FIG. 1, and may be applied to, for example, a computer, a smart phone, a portable electronic device, a tablet, a wearable device, a sensor used in the Internet of Things (IoT), and the like. Hereinafter, an example will be described in which the wireless communication device 700 is a transmitting device.

The wireless communication device 700 may include a main processor 710, a memory 720, a transceiver 730, and/or an antenna array. The main processor 710, the memory 720, the transceiver 730, and/or the antenna array may be directly or indirectly connected to each other. One or more main processors 710, one or more memories 720, and/or one or more transceivers 730 may be included.

The main processor 710 may be electrically connected to the transceiver. The main processor 710 may control the memory 720 and the transceiver 730.

According to embodiments, the main processor 710 may execute one or more instructions to obtain an NDPA frame including one or more fields associated with an encoder for encoding channel information, and transmit the NDPA frame to a station through a transceiver.

The memory 720 may be electrically connected to the main processor and store one or more instructions. In addition, a PPDU format 721 and/or bandwidth field information 724 may be stored in the memory 720. The transceiver 730 may generate a PPDU by using the PPDU format 721 and/or bandwidth field information 724 stored in the memory 720. The transceiver 730 may transmit the generated PPDU to an external receiving device (e.g., STA) through an antenna array.

In this case, the memory 720 may store the PPDU format 721 including a signal field related format according to embodiments of the present application. In addition, the memory 720 may store processor-executable instructions that execute the RU allocation module 722 (or Multi-RU allocation module 722) and/or a PPDU generation module 723. The processor-executable instructions stored in the memory 720 may be executed by a signal processor 731 included in the main processor 710 or the transceiver 730.

For reference, the RU allocation module 722 may use a RU allocation algorithm, method, or policy to allocate RUs to users (e.g., STAs) according to embodiments of the present application. In addition, the PPDU generation module 723 may generate signaling and indication related to RU allocation in the control field of the PPDU (e.g., also called a signaling field, and referred to as a signaling field hereinafter).

According to embodiments, the memory 720 may store an encoder and/or decoder that are/is commonly configured for channel information, bandwidth, and/or grouping values. The memory 720 may store training data for machine learning of the encoder and/or decoder.

The transceiver 730 according to embodiments may include the signal processor 731. In addition, the signal processor 731 may have various modules (e.g., various modules of the transmit path) configured to generate each section of the PPDU or various types of communication transmission units.

Although FIG. 36 illustrates an example in which the signal processor 731 is included in the transceiver 730, this is merely an example and embodiments are not limited thereto, and the signal processor 731 may be implemented as a separate configuration separated from the transceiver 730.

In detail, the signal processor 731 may include a transmit first-in-first-out (TX FIFO) 732, an encoder 733, a scrambler 734, an interleaver 735, a constellation mapper (which may generate, for example, a QAM symbol) 736, a guard interval and windowing insertion module (which may insert a guard interval in a frequency domain to reduce interference on a spectrum and transform a signal through windowing) 737, and/or an inversed discrete Fourier transformer (IDFT) 738.

For reference, the transceiver 730 may include components well known to those skilled in the art as illustrated in the drawings. In addition, the corresponding components may be executed in a manner well known to those skilled in the art, and may be executed using hardware, firmware, software logic, or a combination thereof.

Of course, when the wireless communication device 700 is a receiving device, the transceiver 730 illustrated in FIG. 36 may also include components in a receiving path.

That is, when the wireless communication device 700 is a receiving device, the transceiver 730 may receive a PPDU including a preamble and a payload from a transmitting device. In addition, the transceiver 730 may decode the payload based on the preamble of the received PPDU. That is, the transceiver 730 may identify an RU allocated to the receiving device by decoding the preamble of the PPDU through an internal decoder (not shown), and may decode the payload transmitted to the receiving device (e.g., the payload received from the transmitting device) based on the identified RU.

Of course, the subject of the decoding task may be a component other than the transceiver 730 (e.g., the main processor 710, or the like), but in embodiments of the present application, an example of decoding a payload based on the preamble of a PPDU received by the transceiver 730 will be described.

FIG. 36 only illustrates an example of the wireless communication device 700, and embodiments of the present application are not limited thereto. That is, various changes may be made in FIG. 36.

According to the present application, a device and a method for performing a sounding sequence in a wireless communication system may be provided.

Conventional devices and methods for reporting channel information involve transmitting a beamforming feedback matrix (e.g., angle information) and/or a delta SNR. Such channel information is large in size resulting in excessive feedback overhead and corresponding resource consumption (e.g., bandwidth, processor, power, etc.).

However, according to embodiments, improved devices and methods are provided for reporting channel information. For example, the improved devices and methods may involve encoding the channel information to be reported, thereby reducing the feedback overhead. Also, according to some examples, the improved devices and methods may involve configuring an encoder used to encode the channel information based on information provided in an NDPA frame. For instance, the encoder may be based on an AI model and the NDPA frame may include information for configuring the AI model. Accordingly, the encoding of the channel information may be adapted for different implementation cases. Therefore, the improved devices and methods overcome the deficiencies of the conventional devices and methods to at least reduce resource consumption (e.g., bandwidth, processor, power, etc.) and/or enable adaptable channel information encoding.

According to embodiments, operations described herein as being performed by the wireless communication system 100, each among the plurality of access points (APs) 101 and 103, each among the plurality of stations (STAs) 111 to 114, each among the at least one network 130, the WLAN beamforming system 200, the beamformer 210, the beamformee 220, the channel estimation circuit 221, the SVD circuit 222, the compression circuit 223, the STA 300, the channel estimation circuit 310, the SVD circuit 320, the compression circuit 330, the input processing circuit 340, the encoder 350, the quantization circuit 360, the STA 400, the SNR calculation circuit 410, the input processing circuit 420, the encoder 430, the quantization circuit 440, the STA 500, the encoding circuit 530, the angle calculation circuit 510, the SNR calculation circuit 520, the encoder 531, the AP 600, the encoder 610, the mapper 620, the decoder 630, the output processing circuit 640, the beamforming circuit 650, the IFFT 660, the DAC 670, the wireless communication device 700, the main processor 710, the transceiver 730, the signal processor 731, the RU allocation module 722, the PPDU generation module 723, the encoder 733, the scrambler 734, the interleaver 735, the constellation mapper 736, the guard interval and windowing insertion module 737, and/or the IDFT 738 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 720, the TX FIFO 732, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

In embodiments, the processing circuitry may perform some operations (e.g., the operations described herein as being performed by the encoder 350, the encoder 430, the encoder 531, the encoder 610, the decoder 630, etc.) by artificial intelligence and/or machine learning. As an example, the processing circuitry may implement an artificial neural network (e.g., the encoder 350, the encoder 430, the encoder 531, the encoder 610, the decoder 630, etc.) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning model (e.g., the encoder 350, the encoder 430, the encoder 531, the encoder 610, the decoder 630, etc.) may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but embodiments are not limited thereto. Non-limiting examples of the artificial neural network may include a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Embodiments have been described above. The present disclosure may include not only the above-described examples, but also simple design changes or easily changeable examples. In addition, the present disclosure may include techniques that may easily modify and implement embodiments. Therefore, the scope of the present disclosure should not be limited to the above-described examples, but should be defined by the claims described below as well as the claims and equivalents.

What is claimed is:

1. A method of an access point communicating with a station in a wireless local area network (WLAN) system, the method comprising:
obtaining a null data packet announcement (NDPA) frame including one or more fields, the one or more fields being associated with an encoder for encoding channel information; and
transmitting the NDPA frame to the station.

2. The method of claim 1, wherein the channel information includes angles, a delta signal-to-noise ratio (SNR) and a channel quality indicator (CQI), the angles being included in a compressed beamforming feedback matrix, and the delta SNR being defined as a difference between an SNR of a sub-carrier and an average SNR.

3. The method of claim 1, wherein the one or more fields include a first field indicating whether the channel information is an encoding target and a second field for setting the encoder.

4. The method of claim 3, wherein the first field includes an identifier subfield and an artificial intelligence (AI) compression mode subfield, the identifier subfield identifying the first field, and the AI compression mode subfield including a plurality of bits indicating the encoding target according to a type of the channel information.

5. The method of claim 3, wherein
the station is a first station among a plurality of stations; and
the second field is configured for each among the plurality of stations.

6. The method of claim 3, wherein the second field includes:
an identifier subfield for identifying the station;
a layer number subfield indicating a number of layers to be included in the encoder;
a node count subfield indicating a number of nodes for the encoder;
a weight information subfield indicating a weight for the encoder;
a bias information subfield indicating a bias value for the encoder; and
an activation function information subfield indicating an activation function for the encoder.

7. The method of claim 6, wherein the weight information subfield indicates:
weights for angles included in a compressed beamforming feedback matrix; and
a weight for a delta SNR defined as a difference between an SNR of a subcarrier and an average SNR.

8. The method of claim 6, wherein the layer number subfield indicates a number of input layers, intermediate layers and output layers included in the encoder.

9. The method of claim 6, wherein the node count subfield indicates a number of nodes of each layer included in the encoder.

10. The method of claim 6, wherein the second field further includes an additional information subfield including at least one of:
a number of quantization bits for encoded channel information from the encoder; or
a preprocessing function to be applied to the channel information.

11. The method of claim 3, wherein the second field is configured according to a type of the channel information.

12. The method of claim 3, wherein
the encoder includes a plurality of encoders, each among the plurality of encoders corresponding to a different type of the channel information; and
the second field is configured for each of the plurality of encoders.

13. The method of claim 1, further comprising:
transmitting a null data packet (NDP) to the station, the NDP corresponding to the NDPA frame; and
receiving a compressed beamforming report (CBR) frame from the station based on the transmitting the NDP, the CBR frame including the channel information encoded based on the encoder.

14. The method of claim 13, wherein the CBR frame includes:
a multiple-input multiple-output (MIMO) control field including setting information of the encoder; and
a beamforming report field including the channel information encoded based on the encoder.

15. An access point communicating with a station in a wireless local area network (WLAN) system, the access point comprising:
one or more transceivers;
one or more processors electrically connected to the one or more transceivers; and
one or more memories electrically connected to the one or more processors to store one or more instructions,
wherein the one or more processors are configured to execute the one or more instructions to,
obtain a null data packet announcement (NDPA) frame including one or more fields, the one or more fields being associated with an encoder for encoding channel information, and
transmit the NDPA frame to the station through the one or more transceivers.

16. The access point of claim 15, wherein the one or more fields includes a first field indicating whether the channel information is an encoding target and a second field for setting the encoder.

17. The access point of claim 16, wherein the first field includes an identifier subfield and an artificial intelligence (AI) compression mode subfield, the identifier subfield identifying the first field, and the AI compression mode subfield including a plurality of bits indicating the encoding target according to a type of the channel information.

18. The access point of claim 16, wherein the second field includes:
an identifier subfield for identifying the station;
a layer count subfield indicating a number of layers to be included in the encoder;
a node count subfield indicating a number of nodes for the encoder;
a weight information subfield indicating a weight for the encoder;
a bias information subfield indicating a bias value for the encoder; and
an activation function information subfield indicating an activation function for the encoder.

19. The access point of claim 15, wherein the one or more processors execute the one or more instructions to:
transmit a null data packet (NDP) to the station through the one or more transceivers, the NDP corresponding to the NDPA frame; and
receive a compressed beamforming report (CBR) frame from the station through the one or more transceivers based on the transmission of the NDP, the CBR frame including the channel information encoded based on the encoder.

20. A method of a station communicating with an access point in a wireless local area network (WLAN) system, the method comprising:
receiving a null data packet announcement (NDPA) frame including one or more fields, the one or more fields being associated with an encoder;
receiving a null data packet (NDP) from the access point, the NDP corresponding to the NDPA frame;
estimating channel information based on the NDP;
encoding the channel information based on the encoder to obtain encoded channel information; and
transmitting a compressed beamforming report (CBR) frame to the access point, the CBR frame including the encoded channel information.
